(19) United States
(12) Patent Application Publication
(10) Pub. No.: US 2007/0200520 A1
(43) Pub. Date: Aug. 30, 2007

(54) Vehicle electronic controller and vehicle brake electronic controller

(76) Inventor: Yasunori Sakata, Toyota-city (JP)

Correspondence Address: SUGHRUE MION, PLLC, 2100 PENNSYLVANIA AVENUE, N.W., SUITE 800, WASHINGTON, DC, 20037, US

(21) Appl. No.: 11/708,636

(22) Filed: Feb. 21, 2007

(30) Foreign Application Priority Data
Feb. 24, 2006 (JP) 2006-049073
Dec. 28, 2006 (JP) 2006-356625

(51) Int. Cl. H02P 3/10

(52) U.S. Cl. 318/373

(57) ABSTRACT

A vehicle electronic controller comprises a load such as electric motor or one or more solenoids each connected in series to a power supply; a load state detection sensor for detecting the state of the load; a required minimum drive voltage calculation microprocessor for calculating a required minimum drive voltage which is a drive voltage to be supplied to the load and which is a required lowest voltage, based on the state of the load detected by the load state detection sensor; and a power supply relay circuit arranged between the power supply and the load for transforming a power voltage supplied from the power supply into the required minimum drive voltage calculated by the required minimum drive voltage calculation microprocessor to supply the transformed voltage as the drive voltage to the load.

### INCORPORATION BY REFERENCE

This application is based on and claims priority under 35 U.S.C. 119 with respect to Japanese Applications No. 2006-49073 and No. 2006-356625 respectively filed on Feb. 24 and Dec. 28, 2006, the entire contents of which are incorporated herein by reference.

### BACKGROUND OF THE INVENTION

1. Field of the Invention

The present invention relates to a vehicle electronic controller and a vehicle brake electronic controller.

2. Discussion of the Related Art

Heretofore, as vehicle brake electronic controllers, there has been known one incorporated in a brake system described in Japanese unexamined, published patent application No. 07-261837. In this brake system, as shown in FIG. 2 of the Japanese application, respective exciting coils of solenoids SOL1 to SOL6 being loads are connected to a plus terminal (illustrated as +B in FIG. 2) of a battery of a vehicle (not shown) at one ends thereof and to a controller 22 at other ends thereof and thus, can be operated to be brought into ON or OFF. Further, FIG. 1 of the Japanese application shows a microprocessor 30, constituting a part of the controller 22, and a solenoid drive section 32. The other ends of the exciting coils of the solenoids SOL1 to SOL6 are connected respectively to drains of power MOSFETs 1 to 6 (switching means) of the solenoid drive section 32. The power MOSFETs 1 to 6 are connected at gates thereof to signal output ports OUT#1 to OUT#6 of the microprocessor 30 and are grounded at sources. In the brake system constructed as aforementioned, when a MOSFET is turned to ON, the battery voltage is applied to a solenoid SOL connected to the turned-on MOSFET to excite the exciting coil of the solenoid.

The aforementioned vehicle brake electronic controller executes vehicle behavior controls such as ABS control, traction control and the like, wherein the attraction forces (voltages/currents) required for solenoid drive differ in dependence on the kinds of controls to be executed. Further, the supply voltage from the battery fluctuates in dependence on the state in use. That is, it may be the occasion that the supply voltage (e.g., the battery voltage) is higher than the voltage needed for solenoid drive, in which occasion, a higher voltage than that needed is applied to the MOSFETs (switching elements), thereby giving rise to a problem that the MOSFETs are heated over a designed value to become a high temperature.

On the other hand, the vehicle behavior controls include a control for assisting the driver during the traveling on a steep slope. In this control, the vehicle speed on a down slope is controlled constant by, for example, controlling brakes for respective wheels of the vehicle independently. Because this control is longer in control period of time than ABS control and traction control, it is necessary to elongate the voltage application time to the switching elements by suppressing the temperature increase of the switching elements as far as possible. Further, there has been desired to make the solenoid drive section integrated for miniaturization.

The aforementioned various problems may occur not only with solenoids but also with other loads such as, for example, electric motors. That is, a required output (voltage/current) for the drive of an electric motor differs occasionally, and the supply voltage from a battery fluctuates occasionally in dependence on the state in use, which may give rise a problem that the electric motor generates heat to become a high temperature as a result that a higher voltage than that required is applied thereto. For longer-time driving of the electric motor, it is necessary to suppress the electric motor, from rising to a high temperature as far as possible.

### SUMMARY OF THE INVENTION

Accordingly, it is a primary object of the present invention to provide a vehicle electronic controller and a vehicle brake electronic controller which are capable of suppressing the heat generation of a load and/or switching means for the load as far as possible by applying to the load a drive voltage which is appropriate in terms of the required voltage for the driving of the load, so that the voltage application period of time to the load and/or the switching means for the load can be extended to be as long as possible.

Briefly, in a first aspect of the present invention, there is provided a vehicle electronic controller, which comprises at least one load connected in series to a power supply; load state detection means for detecting the state-of the at least one load; required minimum drive voltage calculation means for calculating a required minimum drive voltage which is a drive voltage to be supplied to the at least one load and which is a required lowest voltage, based on the state of the at least one load detected by the load state detection means; and power supply relay means arranged between the power supply and the at least one load for transforming a power voltage supplied from the power supply into the required minimum drive voltage calculated by the required minimum drive voltage calculation means to supply the transformed voltage as the drive voltage to the at least one load.

With the construction in the first aspect, the required minimum drive voltage calculation means calculates the required minimum drive voltage which is the drive voltage to be supplied to the load and which is the required lowest voltage, based on the state of the load detected by the load state detection means, and the power supply relay means transforms the power voltage supplied from the power supply into the required minimum drive voltage calculated by the required minimum drive voltage calculation means and supplies the transformed voltage as the drive voltage to the load. Therefore, regardless of the difference in the kinds of the controls to be executed and regardless of the fluctuation in the supply voltage from the battery in dependence on the state in use, it is possible to apply an appropriate voltage corresponding to the voltage required for the driving of the load, to the load or the switching means for the load. Accordingly, the heat generation of the load or the switching means for the load can be suppressed to be as small as possible, so that the voltage application period of time to the load or the switching means for the load can be extended to be as long as possible.

In a second aspect of the present invention, there is provided a vehicle electronic controller, which comprises a plurality of solenoids connected to a power supply in series and mutually in parallel for respectively selectively driving a plurality of electric/electronic components; a plurality of switching means provided in series respectively to a plurality of current supply paths which are provided for applying drive current from the power supply to the respective solenoids, for making the drive voltages thereto ON or OFF independently of one another in dependence respectively on ON/OFF signals supplied thereto independently; current detection means for detecting drive currents flowing respectively through the solenoids; resistance value calculation means for calculating respective resistance values across the solenoids based on the respective drive currents detected by the current detection means; required minimum drive voltage calculation means for calculating a required minimum drive voltage based on the resistance values calculated by the resistance value calculation means; and power supply relay means arranged between the power supply and the solenoids for transforming a power voltage supplied from the power supply into the required minimum drive voltage calculated by the required minimum drive voltage calculation means to supply the transformed voltage as the drive voltage to the respective solenoids.

With this construction in the second aspect, the resistance value calculation means calculates respective resistance values of the solenoids based on the respective drive currents detected by the current detection means, the required minimum drive voltage calculation means calculates the required minimum drive voltage based on the resistance values calculated by the resistance value calculation means, and the power supply relay means transforms the power supply voltage supplied from the power supply into the required minimum drive voltage calculated by the required minimum drive voltage calculation means and supplies the transformed voltage as the drive voltage to the solenoids. Thus, regardless of the difference in the kinds of controls to be executed and regardless of the fluctuation in the supply voltage from the battery in dependence on the state in use, it is possible to apply an appropriate supply voltage depending on the voltage required for the driving of the solenoids, to the switching means. Accordingly, the heat generation of the switching means can be suppressed to be as small as possible, so that the voltage application period of time to the switching means can be extended to be as long as possible.

In a third aspect of the present invention, there is provided a vehicle electronic controller, which comprises an electric motor connected in series to a power supply; electric motor state detection means for detecting the state of the electric motor; required minimum drive voltage calculation means for calculating a required minimum drive voltage which is a drive voltage to be supplied to the electric motor and which is a required lowest voltage corresponding to a required power for the electric motor, based on the state of the electric motor detected by the electric motor state detection means; and power supply relay means arranged between the power supply and the electric motor for transforming a power voltage supplied from the power supply into the required minimum drive voltage calculated by the required minimum drive voltage calculation means to supply the transformed voltage as the drive voltage to the electric motor.

With this construction in the third aspect, the required minimum drive voltage calculation means calculates the required minimum drive voltage which is the drive voltage to be supplied to the electric motor and which is the required lowest voltage corresponding to the require power for the electric motor, based on the state of the electric motor detected by the electric motor state detection means, and the power supply relay means transforms the power voltage supplied from the power supply into the required minimum drive voltage calculated by the required minimum drive voltage calculation means and supplies the transformed voltage as the drive voltage to the electric motor. Therefore, regardless of the difference in the kinds of controls to be executed and regardless of the fluctuation in the supply voltage from the battery in dependence on the state in use, it is possible to apply to the electric motor an appropriate voltage corresponding to the voltage required for the driving of the electric motor. Accordingly, the heat generation of the electric motor can be suppressed to be as small as possible, so that the voltage application period of time to the electric motor can be extended to be as long as possible.

Further, since no higher voltage than that required is applied to the electric motor, the same is suppressed from rotating at a higher speed than that required, so that it becomes possible to suppress the noise caused by the operation of the electric motor from getting higher superfluously. Further, since the voltage applied to the electric motor is not a voltage altered under PMW control but a constant voltage, the removal of the rotational fluctuation successfully results in reducing the fluctuation of the operation noise, and a surge current which flows through the electric motor at the time of switching the applied voltage from OFF to ON (or ON to OFF) is removed to suppress the electric motor from generating superfluous heat.

In a fourth aspect of the present invention, there is provided a vehicle brake electronic controller for controlling the brake of a vehicle, wherein the vehicle electronic controller as set forth in any of the first to third aspects is applied as the vehicle brake electronic controller.

By applying the vehicle electronic controller as set forth in any of the first to third aspects to the vehicle brake electronic controller, the heat generation of the vehicle brake electronic controller can be suppressed properly, so that the time period for the brake control can be extended as long as possible.

### BRIEF DESCRIPTION OF THE ACCOMPANYING DRAWINGS

The foregoing and other objects and many of the attendant advantages of the present invention may readily be appreciated as the same becomes better understood by reference to the preferred embodiments of the present invention when considered in connection with the accompanying drawings, wherein like reference numerals designate the same or corresponding parts throughout several views, and in which:

FIG. 1 is a schematic circuit diagram of a brake fluid pressure control system incorporating a vehicle brake electronic controller in one embodiment according to the present invention;

FIGS. 2A and 2B are schematic block diagrams collectively showing the controller shown in FIG. 1;

FIG. 3 is a schematic circuit diagram mainly showing a second supply voltage generation circuit;

FIGS. 4 and 5 are flow charts correctively showing a control program executed by the controller shown in FIG. 1;

FIG. 6 is a flow chart for brake fluid pressure control executed by the controller shown in FIG. 1;

FIG. 7 is a time chart demonstrating the operation and effect in the first embodiment;

FIG. 8 is a graph showing the variation of coil temperature in the case that a solenoid is continuously energized at each of different drive voltages;

FIGS. 9A and 9B are schematic block diagrams collectively showing a vehicle brake electronic controller incorporated in a brake fluid pressure control system in a second embodiment according to the present invention;

FIGS. 10 to 12 are flow charts correctively showing a control program executed by the controller in the second embodiment;

FIG. 13 is a flow chart for brake fluid pressure control executed by the controller in the second embodiment;

FIG. 14 is a graph showing the relations between electric motor rotational speeds and drive voltages for various loads;

FIG. 15 is a block diagram showing a modification of electric motor state detection means; and

FIG. 16 is a graph showing the relations between drive currents and drive voltages for various loads in the case that the modified electric motor state detection means is used.

### DETAILED DESCRIPTION OF THE PREFERRED EMBODIMENTS

### First Embodiment

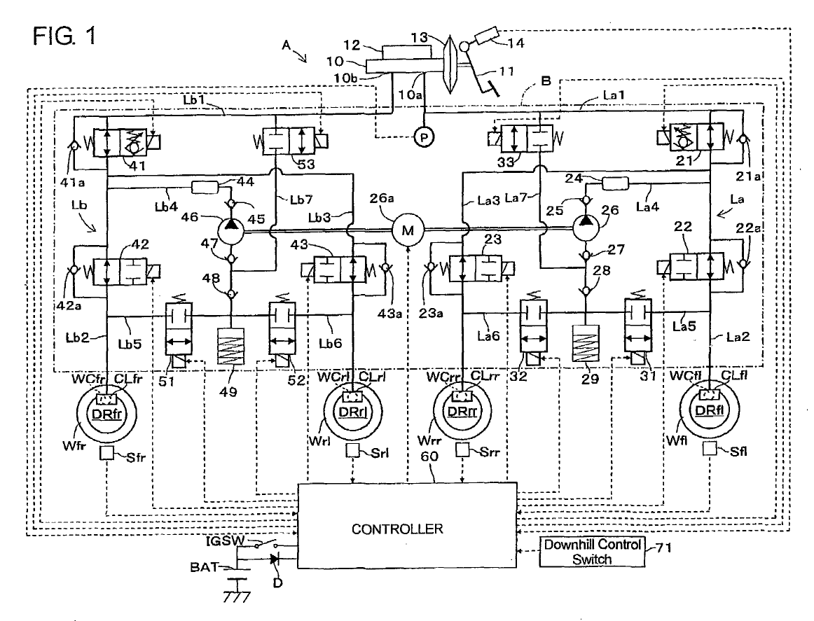

Hereafter, with reference to the drawings, description will be made regarding a vehicle electronic controller in a first embodiment according to the present invention, wherein the controller is applied as a vehicle brake electronic controller to a brake fluid pressure control system. FIG. 1 shows a schematic circuit diagram of the brake fluid pressure control system A. This system A is provided with a master cylinder 10 for generating brake fluid (pressurized base fluid) of the pressure corresponding to the stepping state of a brake pedal 11 to supply the brake fluid to wheel cylinders WCfl, WCrr, WCrl and WCfr which respectively restrict the rotations of wheels Wfl, Wrr, Wrl and Wfr, a reservoir tank 12 for storing brake fluid and for replenishing the brake fluid to the master cylinder 10, a vacuum booster 13 for boosting the stepping force on the brake pedal 11, wheel speed sensors Sfl, Srr, Srl, Sfr for detecting the wheel speeds of the wheels Wfl, Wrr, Wrl and Wfr, an actuator unit B capable of supplying pressurized control fluid to the wheel cylinders WCfl, WCrr, WCrl and WCfr independently of one another regardless of the stepping state of the brake pedal 11 (independently of the pressurized base fluid), and a controller (vehicle brake electronic controller) 60 for controlling the actuator unit B. In the present first embodiment, the brake fluid pressure control system A is used in a front-wheel drive vehicle.

The wheel cylinders WCfl, WCrr, WCrl and WCfr are provided in calipers CLfl, CLrr, CLrl and CLfr and contain therein pistons (not shown) to be slidable fluid-tightly, respectively. When pressurized fluid from the master cylinders 10 is supplied to the wheel cylinders WCfl, WCrr, WCrl and WCfr, the pistons push respective pairs of brake pads (not shown) and pinch or vise disc rotors DRfl, DRrr, DRrl, DRfr rotating bodily with the wheels Wfl, Wrr, Wrl, Wfr from opposite sides thereof to stop the rotations, respectively. Although disc-type brakes are used in the present embodiment, drum-type brakes may be used instead. In this modified case, when pressurized fluid is supplied to the wheel cylinders WCfl, WCrr, WCrl and WCfr, pistons push respective pairs of brake shoes to bring the same into pressure contact on internal surfaces of brake drums rotating bodily with the wheels Wfl, Wrr, Wrl, Wfr to stop the rotations.

An “X” piping arrangement is used to construct a brake piping system of the brake fluid pressure control system A in the first embodiment. First and second output ports 10a, 10b of the master cylinder 10 are connected respectively to first and second pipe lines La, Lb. The first pipe line La makes the master cylinder 10 communicate with the wheel cylinders WCfl, WCrr of the left front wheel Wfl and the right rear wheel Wrr, while the second pipe line Lb makes the master cylinder 10 communicate with the wheel cylinders WCrl, WCfr of the left rear wheel Wrl and the right front wheel Wfr.

The first pipe line La is composed of first through seventh oil passages La1-La7. The first oil passage La1 is connected to the first output port 10a of the master cylinder 10 at its one end. The second oil passage La2 is connected to the first oil passage La1 at its one end and the wheel cylinder WCf1 at the other end. A shut-off valve 21 and a holding valve 22 are arranged on the second oil passage La2 in turn from the master cylinder 10 side. The third oil passage La3 is connected between the shut-off valve 21 and the holding valve 22 on the second oil passage La2, at its one end and is connected to the wheel cylinder WCrr at the other end. A holding valve 23 is arranged on the third oil passage La3. The fourth oil passage La4 is connected between the shut-off valve 21 and the holding valve 22 on the second oil passage La2, at its one end and is connected to a built-in reservoir tank 29 at the other end. A damper 24, a check valve (one-way valve) 25, a pump 26, and check valves 27 and 28 are arranged on the fourth oil passage La4 in turn from the second oil passage La2 side. The fifth oil passage La5 is connected at its one end between the holding valve 22 and the wheel cylinder WCfl on the second oil passage La2 and at the other end between the check valve 28 and the built-in reservoir tank 29 on the fourth oil passage La4. A reducing valve 31 is arranged on the fifth oil passage La5. The sixth oil passage La6 is connected at its one end between the holding valve 23 and the wheel cylinder WCrr on the third oil passage La3 and at the other end between the check valve 28 and the built-in reservoir tank 29 on the fourth oil passage La4. A reducing valve 32 is arranged on the sixth oil passage La6. The seventh oil passage La7 is connected at it one end to the first oil passage La1 and at the other end between the check valves 27 and 28 on the fourth oil passage La4. A replenishing valve 33 is arranged on the seventh oil passage La7.

The shut-off valve 21 is an electromagnetic open/close valve of the normally-open type which selectively makes the master cylinder 10 communicate with the wheel cylinders WCfl, WCrr or blocked therefrom. The shut-off valve 21 is normally held in the communication state (illustrated state) and when brought into the blocked state, serves to hold the pressure on the wheel cylinder WCfl, WCrr side to be higher by a predetermined different pressure than the pressure on the master cylinder 10 side. This difference pressure is adjustable by the controller 60 in dependence on the magnitude of control current applied thereto. The shut-off valve 21 is constructed as a two-position valve which is responsive to a command from the controller 60 to be controllable to the communication state (illustrated state) when de-energized and to the blocked state when energized. The shut-off valve 21 is provided in parallel relation with a check valve 21a for allowing the fluid flow only from the master cylinder 10 toward the wheel cylinders WCfl, WCrr.

The holding valve 22 is an electromagnetic open/close valve of the normally-open type which selectively makes the master cylinder 10 communicate with the wheel cylinder WCfl or blocked therefrom. The holding valve 23 is an electromagnetic open/close valve of the normally-open type which selectively makes the master cylinder 10 communicate with the wheel cylinder WCrr or blocked therefrom. The holding valves 22 and 23 are each constructed as two-position valve which is responsive to a command from the controller 60 to be controllable to the communication state (illustrated state) when de-energized and to the blocked state when energized. The holding valves 22 and 23 are provided in parallel relation respectively with check valves 22a and 23a for allowing the fluid flow only from the wheel cylinders WCfl, WCrr toward the master cylinder 10.

The pump 26 is driven by an electric motor 26a responsive to a command from the controller 60. In a pressure reducing mode under ABS control, the pump 26 communicates at its suction port with the built-in reservoir tank 29 storing the brake fluid, through the check valves 27 and 28 and also communicates at its discharge port with the master cylinder 10 through the check valve 25, the damper 24 and the shut-off valve 21 as well as with the wheel cylinders WCfl and WCrr through the check valve 25, the damper 24 and an associated one of the holding valves 22 and 23. In this communication state, the pump 26 draws brake fluid in the wheel cylinders WCfl and WCrr or brake fluid stored in the built-in reservoir tank 29 to return the drawn fluid to the master cylinder 10. Further, when the replenishing value 33 is brought into communication state during a traction control or a downhill control, the pump 26 communicates at its suction port with the reservoir tank 12 storing brake fluid, through the master cylinder 10 and at its discharge port with the wheel cylinders WCfl and WCrr through the check valve 25, the damper 24 and the associated one of the holding valves 22 and 23. In this communication state, the pump 26 draws the brake fluid stored in the reservoir tank 12 to discharge the fluid with a pressure into the wheel cylinders WCfl and WCrr.

The damper 24 is for mitigating the pulsation in brake oil discharged from the pump 26. The check valve 25 is for preventing brake fluid from flowing back toward the discharge port of the pump 26. The check valve 27 is for preventing brake fluid from flowing reversely away from the pump 26. The check valve 28 is for preventing brake fluid from flowing from the master cylinder 10 into the built-in reservoir 29 under the traction control or the downhill control.

The reducing valve 31 is an electromagnetic open/close valve of the normally-closed type for selectively making the wheel cylinder WCfl communicate with the built-in reservoir tank 29 or blocked therefrom. The reducing valve 32 is an electromagnetic open/close valve of the normally-closed type for selectively making the wheel cylinder WCrr communicate with the built-in reservoir tank 29 or blocked therefrom. The reducing valves 31, 32 are each constructed as two-position valve which is responsive to a command from the controller 60 to be controllable to the blocked state (illustrated state) when de-energized and to the communication state when energized.

Further, the second pipe line Lb has a construction similar to the aforementioned first pipe line La and is provided with first to seventh oil passages Lb1-Lb7, a shut-off valve 41, holding valves 42 and 43, a damper 44, a check valve 45, a pump 46, check valves 47 and 48, a built-in reservoir tank 49, reducing valves 51 and 52, a replenishing valve 53 and so on. These components arranged on the second pipe line Lb perform the same operations as those in the first pip line La do, and therefore, further detailed description thereof will be omitted for the sake of brevity.

The wheel speed sensors Sfl, Srr, Srl, Sfr are provided in the neighborhood of the respective wheels Wfl, Wrr, Wrl, Wfr and output to the controller 60 pulse signals corresponding to the rotational speeds of the respective wheels Wfl, Wrr, Wrl, Wfr.

Further, the first oil passage La1 of the first pipe line La is provided with a pressure sensor P for detecting a master cylinder pressure being the brake pressure in the master cylinder 10, and the detection signal is transmitted to the controller 60. The pressure sensor P may be provided on the first oil passage Lb1 of the second pipe line Lb.

Further, the brake fluid pressure control system A is provided with a stop switch 14, which is brought into ON-state when the brake pedal 11 is stepped and into OFF-state when the stepping is released. An ON/OFF signal from the stop switch 14 is transmitted to the controller 60.

Further, the brake fluid pressure control system A is provided with a downhill control switch 71, which is a switch used for selectively bringing the vehicle downhill control into ON or OFF. An ON/OFF signal from the downhill control switch 71 is transmitted to the controller 60. The downhill control is provided for implementing a brake control to control the vehicle speed in a down slope traveling to a constant speed (e.g., 5 km/h: kilometers per hour) while the downhill control switch 71 is held in ON-state.

Further, the brake fluid pressure control system A is provided with the controller (vehicle brake electronic controller) 60 which is connected to the aforementioned stop switch 14, the pressure sensor P, the electric motor 26a, the respective electromagnetic valves 21-23, 31-33, 41-43 and 51-53, and the various wheel speed sensors Sfl, Srr, Srl, Sfr. A battery voltage being the power voltage from a battery BAT is supplied to the controller 60 through a diode D. Further, An ON/OFF signal from an ignition switch IGSW is inputted to the controller 60.

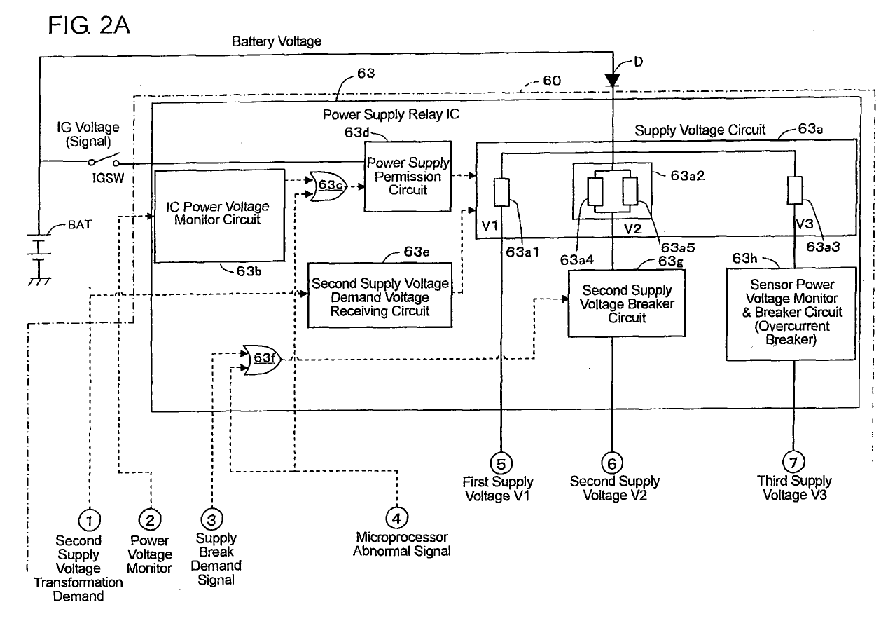

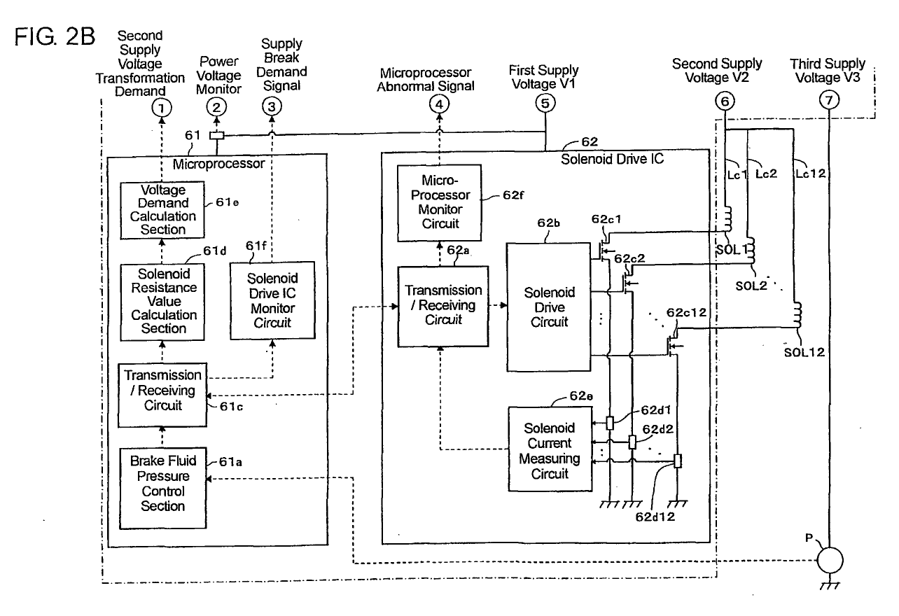

As shown in FIGS. 2A and 2B, the controller 60 is provided with a microprocessor 61, a solenoid drive IC (Integrated Circuit) 62 for controlling the ON/OFF-states of the respective solenoids SOL1-SOL12 upon receipt of commands from the microprocessor 61 to control the operations of the respective electromagnetic valves corresponding to the solenoids SOL1-SOL12, and a power supply relay IC 63 for transforming the power voltage from the battery to various voltages as required therein and for relaying the various voltages to the microprocessor 61, the solenoid drive IC 62, the solenoids SOL1-SOL12, and the pressure sensor P.

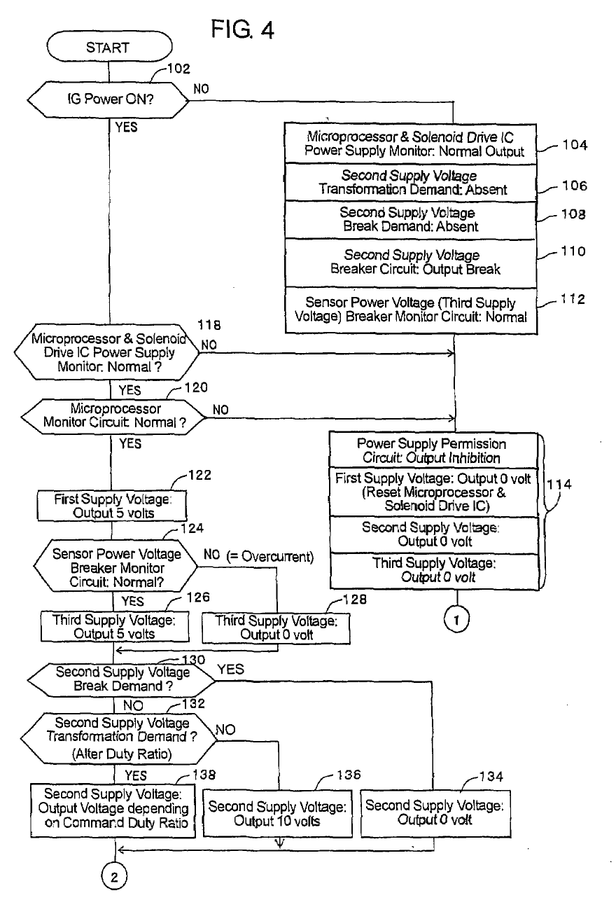

The microprocessor 61 is provided with a brake fluid pressure control section 61a, a transmission/receiving circuit 61c, a solenoid resistance value calculation section 61d, a voltage demand calculation section 61e, and a solenoid drive IC monitor circuit 61f, whose operations will be described with reference to FIGS. 4 to 6.

The brake fluid pressure control section 61a performs the ABS control, the traction control and the downhill control based on inputs from the various wheel speed sensors Sfl, Srr, Srl, Sfr and the pressure sensor P.

The transmission/receiving circuit 61c is provided for bidirectional communication of information between itself and a transmission/receiving circuit 62a of the solenoid drive IC 62. The transmission/receiving circuit 61c transmits a drive demand from the brake fluid pressure control section 61a to the solenoid drive IC 62 and receives respective current values of the solenoids SOL1-SOL12 measured by a solenoid current measuring circuit 62e.

The solenoid resistance value calculation section 61d calculates respective resistance values on the solenoids SOL1-SOL12 based on the respective current values received by the transmission/receiving circuit 61c. Since the voltage or drive voltage applied to each solenoid SOL1-SOL12 is a second supply voltage V2, respective resistance values of the solenoids SOL1-SOL12 can be calculated by dividing a second supply voltage V2 demand value by respective current values flowing through the solenoids SOL1-SOL12. Instead, they may be calculated by monitoring an actual second supply voltage V2 supplied to the solenoids SOL1-SOL12 and by dividing the actual second supply voltage V2 by the respective current values.

The voltage demand calculation section (required minimum drive voltage calculation means) 61e is for calculating a required minimum drive voltage based on the resistance values calculated by the solenoid resistance value calculation section 61d. The calculation section 61e selects the maximum resistance value from the respective resistance values of the solenoids SOL1-SOL12 calculated by the solenoid resistance value calculation section 61d and calculates the required minimum drive voltage by multiplying the maximum resistance value by a current value which corresponds to an attraction force required for the solenoids. The required minimum drive voltage so calculated is transmitted as a second supply voltage transformation demand signal to a second supply voltage demand voltage receiving circuit 63e of the power supply relay IC 63. The current values corresponding to the attraction force required for the solenoids differ in dependence on the kinds of the vehicle behavior controls. For example, the current value is 2.5 A (amperes) for the ABS control and 1.5 A for the traction control. The second supply voltage transformation demand signal is a signal indicative of a duty ratio representing a voltage. For example, voltages at 10 to 16 volts are represented by duty ratios of 20 to 80%. The second supply voltage transformation demand signal may be an PWM signal output or may be a serial transmission output given by means of communication.

The solenoid drive IC monitor circuit (solenoid drive IC monitor means) 61f is for monitoring the operation of the solenoid drive IC 62 based on the operating state and communication state of the solenoid drive IC 62. Specifically, the operation of the solenoid drive IC 62 is judged to be normal when the state in which no information is received from the solenoid drive IC 62 does not continue or last over a predetermined time Ti and when any wire break and any short-circuit do not occur with the solenoid drive IC 62, but is judged to be abnormal when not so. When detecting the abnormality of the solenoid drive IC 62, the solenoid drive IC monitor circuit 61f transmits a supply break demand signal for requesting that the supply of the second supply voltage V2 be broken, to an OR gate 63f of the power supply relay IC 63.

The solenoid drive IC 62 is composed of the transmission/receiving circuit 62a, the solenoid drive circuit 62b, a plurality of switching elements 62c1-62c12, a plurality of current detection elements 62d1-62d12, the solenoid current measuring circuit 62e, and a microprocessor monitor circuit 62f.

The transmission/receiving circuit 62a is for mutual communication with the transmission/receiving circuit 61c of the microprocessor 61. The circuit 62a receives a drive demand from the brake fluid pressure control section 61a and transmits to the microprocessor 61 the respective current values for the solenoids SOL1-SOL12 which values are measured by the solenoid current measuring circuit 62e.

The solenoid drive circuit 62b is for controlling the drive voltages in an ON-OFF manner which are applied to the solenoids as controlled objects in response to the drive demands received by the transmission/receiving circuit 62a. The circuit 62b controls the energization/de-energization of the switching elements 62c1-62c12 by transmitting to the same ON/OFF signals corresponding to the drive demand commands from the microprocessor 61. That is, energization of the solenoids SOL1-SOL12 corresponding to the switching elements 62c1-62c12 are executed in response to ON-signals, while de-energization of the solenoids SOL1-SOL12 are executed in response to OFF-signals. Further, the second supply voltage V2 supplied from the power supply relay IC 63 is applied to each of the solenoids SOL1-SOL12. These solenoids SOL1-SOL12 are those provided respectively on the electromagnetic valves 21-23, 31-33, 41-43 and 51-53.

The switching elements (switching means) 62c1-62c12 are constituted by, e.g., MOSFETs (MOS type field-effect transistors). The elements 62c1-62c12 are provided in series to the solenoids SOL1-SOL12 on current supply paths Lc1-Lc12, respectively. Specifically, respective drains of the switching elements 62c1-62c12 are connected to an output port for the second supply voltage V2 of the supply voltage circuit 63a respectively through the solenoids SOL1-SOL12 and through a second supply voltage breaker circuit 63g. Gates of the switching elements 62c1-62c12 are connected respectively to output ports (not shown) of the solenoid drive circuit 62b. The switching elements 62c1-62c12 are grounded at sources thereof respectively through the current detection elements 62d1-62d12.

The current detection elements 62d1-62d12 are constituted by, e.g., shunt resistances. Both ends of each shunt resistance is connected to the solenoid current measuring circuit 62e, and the circuit 62e inputs voltages values across the shunt resistances, so that it detects the current values (drive currents) flowing through the solenoids SOL1-SOL12 to transmit the detection results to the transmission/receiving circuit 62a.

The microprocessor monitor circuit (microprocessor monitor means) 62f is for monitoring the operation of the microprocessor 61 based on the operational state and communication state of the microprocessor 61 which states are received by the transmission/receiving circuit 62a. When detecting an abnormality of the microprocessor 61, the monitor circuit 62f transmits a microprocessor abnormal signal (high level) indicative of the abnormality of the microprocessor 61, to OR gates 63c and 63f of the power supply relay IC 63.

The power supply relay IC 63 is composed of the supply voltage circuit 63a, a power voltage monitor circuit (hereafter referred to as IC power voltage monitor circuit) 63b for the microprocessor 61 and the solenoid drive IC 62, the OR gate 63c, a power supply permission circuit 63d, the second supply voltage demand voltage receiving circuit 63e, the OR gate 63f and the second supply voltage breaker circuit 63g and a sensor power voltage monitor and breaker circuit 63h.

The supply voltage circuit 63a inputs a power voltage (battery voltage) supplied from the power supply (battery BAT) thereto and generates the first supply voltage V1, the second supply voltage V2 and a third supply voltage V3 to output them respectively from output ports OUT1-OUT3 (not shown) thereof. The first supply voltage V1 is a voltage (e.g., 5 volts) supplied as power voltage for the microprocessor 61 and the solenoid drive IC 62. The second supply voltage V2 is a voltage (e.g., 10 to 16 volts) which is supplied to be transformable as the drive voltage for the respective solenoids. The third supply voltage V3 is a voltage (e.g., 5 volts) supplied as supply voltage for the pressure sensor P.

The supply voltage circuit 63a is composed of first and second step-down circuits 63a1, 63a3 which respectively generate the first and third supply voltages V1, V3 by stepping down the battery voltage, and a second supply voltage generation circuit 63a2 which transforms the power voltage (battery voltage) supplied from the power supply (battery BAT) to a required minimum drive voltage and supplies the same as the second supply voltage V2 being the drive voltage, to the respective solenoids SOL1-SOL12.

The second supply voltage generation circuit 63a2 is further composed of a step-down circuit (step-down means) 63a4 for effecting a step-down transformation so that the power voltage supplied from the power supply BAT becomes a required voltage value inputted from the second supply voltage demand voltage receiving circuit 63e, to supply the stepped-down voltage as the drive voltage to the respective solenoids SOL1-SOL12, and a step-up circuit (step-up means) 63a5 for effecting a step-up transformation so that the power voltage becomes the required voltage value inputted from the second supply voltage demand voltage receiving circuit 63e, to supply the stepped-up voltage as the drive voltage to the respective solenoids SOL1-SOL12. The relation in magnitude between the battery voltage and the required voltage value determines whether to use the step-down circuit 63a4 or the step-up circuit 63a5. Thus, the step-down circuit 63a4 is used when the battery voltage is higher than the required voltage value, whereas the step-up circuit 63a5 is used when the former is lower than the latter.

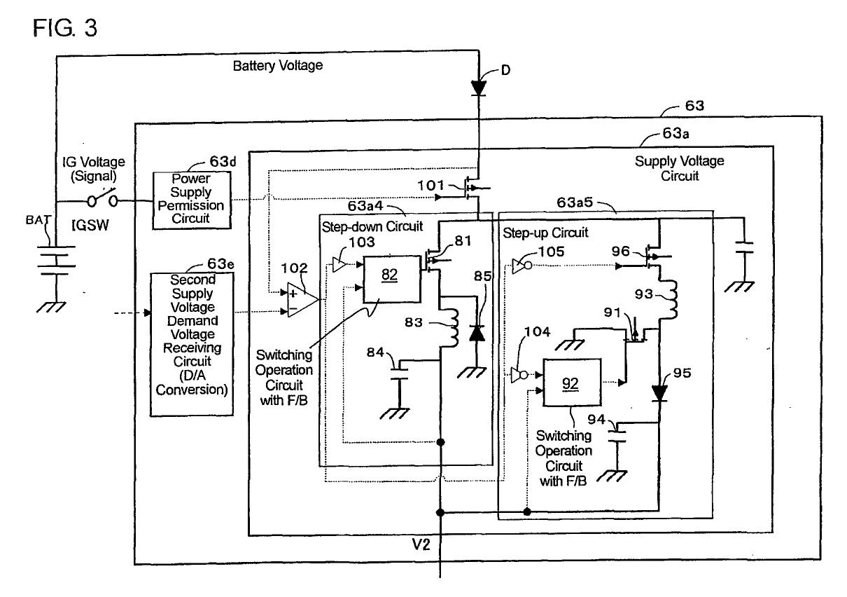

The step-down circuit 63a4 is a generally well-known step-down circuit and as shown in FIG. 3, is composed a switching element (e.g., MOSFET) 81, a feedback functioning switching operation circuit 82 for controlling the switching element 81 in an ON/OFF manner, a coil 83, a condenser 84, and a diode 85. The switching element 81 and the coil 83 are connected in series between the power supply BAT and the loads (solenoids). The condenser 84 is connected between the coil 83 and the loads at its one end and is grounded at the other end. A cathode of the diode 85 is connected between the switching element 81 and the coil 83, and an anode thereof is grounded. The feedback functioning switching operation circuit 82 performs the feedback control of the output voltage.

The step-up circuit 63a5 is a generally well-known step-up circuit and as shown in FIG. 3, is composed a switching element (e.g., MOSFET) 91, a feedback functioning switching operation circuit 92 for controlling the switching element 91 in an ON/OFF manner, a coil 93, a condenser 94, a diode 95, and a switching element 96. The coil 93 and the diode 95 are connected in series between the power supply BAT and the loads (solenoids). An anode of the diode 95 is connected to the coil 93. A drain of the switching element 91 is connected between the coil 93 and the diode 95, and a source thereof is grounded. The condenser 94 is connected between the diode 95 and the loads at its one end and is grounded at the other end. The switching element 96 is connected at the front stage of the coil 93 with respect to the power supply BAT. The feedback functioning switching operation circuit 92 performs the feedback control of the output voltage.

The supply voltage circuit 63a is further provided with a switching element 101 which is connected between the diode D and the second supply voltage generation circuit 63a2 (also between the diode D and the first and second step-down circuits 63a1, 63a3). The switching element 101 is controllable by the signal from the power supply permission circuit 63d in an ON/OFF manner. Further, the supply voltage circuit 63a is provided with a comparator 102. The comparator 102 compares the voltage of the power supply BAT with the required voltage value inputted thereto from the second supply voltage demand voltage receiving circuit 63e and outputs to a buffer 103 and inverters 104, 105 a high-level signal if the power voltage is higher, but a low-level signal if the power voltage is lower. The buffer 103 outputs the signal from the comparator 102 to the feedback functioning switching operation circuit 82 without inverting the signal. The inverter 104 outputs the signal from the comparator 102 to the switching element 92 after inverting the signal. The inverter 105 outputs the signal from the comparator 102 to the switching element 96 after inverting the signal. Thus, either the step-down circuit 63a4 or the step-up circuit 63a5 operates in dependence on the magnitude of the required voltage.

The IC power voltage monitor circuit 63b monitors the first supply voltage V1 supplied from the output port OUT1 of the supply voltage circuit 63a to the microprocessor 61 and the solenoid drive IC 62. When detecting an abnormality (e.g., V1<4.5 volts) of the first supply voltage V1, the monitor circuit 63b transmits to the OR gate 63c a first supply voltage abnormal signal (high-level) indicating that the microprocessor 61 is abnormal.

The OR gate 63c outputs an abnormal signal (high level) indicating the abnormality of the microprocessor 61, to the power supply permission circuit 63d when inputting the microprocessor abnormal signal (high level) from the microprocessor monitor circuit 62f or when inputting the first supply voltage abnormal signal (high level) from the IC power voltage monitor circuit 63b.

The power supply permission circuit 63d inputs an ON/OFF signal of the ignition switch IGSW and the abnormal signal from the OR gate 63c. When inputting an OFF signal from the ignition switch IGSW or when inputting the abnormal signal (high level) from the OR gate 63c, the power supply permission circuit 63d does not output the permission for power supplying to the supply voltage circuit 63a, whereby the respective supply voltages are not outputted. On the other hand, when inputting an ON signal from the ignition switch IGSW and when not inputting the abnormality signal from the OR gate 63c (in other words, when the output from the OR gate 63c is at low level), the power supply permission circuit 63d outputs the permission for power supplying to the supply voltage circuit 63a, whereby the respective supply voltages are outputted.

The second supply voltage demand voltage receiving circuit 63e calculates a required voltage value based on the second supply voltage transformation demand signal inputted from the voltage demand calculation section 61e and outputs the calculation result to the second supply voltage generation circuit 63a2. The transformation demand signal may be a PWM signal output or may be a serial transmission output given by means of communication.

The OR gate 63f outputs a breaker signal (high level) for breaking the second supply voltage V2, to the second supply voltage breaker circuit 63g when inputting the microprocessor abnormal signal from the microprocessor monitor circuit 62f or when inputting the supply break demand signal (high level) from the solenoid drive IC monitor circuit 61f.

The second supply voltage breaker circuit 63g permits the second supply voltage V2 to be supplied when not inputting the break demand signal from the OR gate 63f (in other words, when the output from the OR gate 63f is at low level), but breaks the supplying of the second supply voltage V2 when inputting the break demand signal from the OR gate 63f (in other words, when the output from the OR gate 63f is at high level).

The sensor power voltage monitor and breaker circuit 63h is provided for monitoring the third supply voltage V3 which is supplied from the output OUT3 of the supply voltage circuit 63a to the pressure sensor P. The monitor and breaker circuit 63h breaks the supplying of the third supply voltage V3 when detecting the abnormality (e.g., overcurrent caused by a short-circuit) of the third supply voltage V3.

Further, the microprocessor 61 is provided with an input/output interface, a CPU, a RAM and a ROM (all not shown). By executing a program corresponding to flow charts shown in FIGS. 4 through 6, the CPU controls the switching of open/close operations of the respective electromagnetic valves 21-23, 31-33, 41-43, 51-53 under various vehicle behavior controls and operates the electric motor 26a whenever necessary, so that adjustment is made of brake fluid pressures given to the wheel cylinders WCfl, WCrr, WCrl, WCfr, that is, brake forces given to the respective wheels Wfl, Wrr, Wrl, Wfr.

### (Operation)

Next, description will be made regarding the vehicle behavior controls for the brake fluid pressure control system A as constructed above. The vehicle behavior controls described here include ABS control, traction control and downhill control.

The ABS control will be described first. When detecting the ON state of the stop switch 14 indicating that a braking operation is being performed, the controller 60 (microprocessor 61) takes thereinto the wheel speeds Vw detected by the wheel speed sensors Sfl-Sfr at a predetermined time interval, infers a vehicle body speed Vs based on the wheel speeds Vw of the four wheels, and applies an optimum brake force to each of the wheels so that the difference of each wheel speed Vw from the vehicle body speed Vs does not go beyond a predetermined value.

Further, in the traction control, the controller 60 (microprocessor 61) takes thereinto the wheel speeds Vw detected by the wheel speed sensors Sfl-Sfr at the predetermined time interval regardless of the manipulation or non-manipulation by the driver of the brake pedal 11 and infers the vehicle body speed Vs based on the wheel speeds Vw of the four wheels, and applies an optimum brake force to each of the wheels so that the difference of each wheel speed Vw from the vehicle body speed Vs does not go beyond a predetermined value. That is, the traction control is operated to prevent driving wheels from slipping when the vehicle starts on a road which is small in friction coefficient such as snow-covered road.

Further, the downhill control is operated to maintain the vehicle body speed at a predetermined speed on the occasion where the descent by the driver's manipulation is difficult at an off-load site or on a snow-covered downhill, so that it is a comfortable and useful function which enables the driver to concentrate himself/herself on the steering manipulation.

When the downhill switch 71 is turned to ON state, the downhill control is operated without the manipulation of the brake pedal 11 and a gas pedal (not shown). When the driver manipulates either the brake pedal 11 or the gas pedal for deceleration or acceleration, the downhill control is halted with the downhill control switch 71 remaining in ON state. Further, under the downhill control, the wheel cylinder for each wheel is increased or decreased in pressure based on the difference between the wheel speed and the vehicle body speed to hold a predetermined speed.

More specifically, under the downhill control, when detecting that the downhill control switch 71 has been turned to ON state, the controller 60 (microprocessor 61) takes thereinto the wheel speeds Vw detected by the wheel speed sensors Sfl-Sfr at the predetermined time interval with the brake pedal 11 being not manipulated by the driver, infers the vehicle body speed Vs based on the wheel speeds Vw of the four wheels, and applies an optimum brake force to each of the wheels so that the vehicle body speed Vs does not go beyond a predetermined speed.

The operation of the vehicle brake electronic controller as constructed above will be described in accordance with the flow charts shown in FIGS. 4 through 6. The controller 60 repetitively executes the program corresponding to the flow charts at a predetermined time interval (operation cycle time of, e.g., 5 milliseconds).

Unless the ignition switch IGSW has been turned to ON, the controller 60 makes a judgment of “NO” at step 102 and repetitively executes steps 102-114. The controller 60 at step 104 executes a setting that the IC power voltage monitor circuit 63b detects the normality of the first supply voltage V1. That is, a first supply voltage abnormal signal outputted from the IC power voltage monitor circuit 63b is set to a low level. At step 106, it is set that the second supply voltage transformation demand is absent. At step 108, it is set that the second supply voltage break demand is absent. At step 110, the second supply voltage breaker circuit 63g is set to break the outputs therefrom. At step 112, it is set that the sensor power voltage monitor and breaker circuit 63h detects the normality of the third supply voltage V3. Further, at step 114, the controller 60 outputs a supply inhibition command to the power supply permission circuit 63d to make the outputs of the first to third supply voltages V1-V3 zero volt.

When the ignition switch IGSW is turned to ON, on the contrary, the controller 60 makes a judgment of “YES” at step 102, and the processing subsequent to step 122 are executed when the microprocessor 61 is normal, whereas the supply inhibition command is outputted to the power supply permission circuit 63d to make the outputs of the first to third supply voltages V1-V3 zero volt at step 114 if the microprocessor 61 is abnormal. That is, the controller 60 at step 118 monitors the microprocessor/solenoid drive power voltage (i.e., the first supply voltage V1) by the IC power voltage monitor circuit 63b. The controller 60 at step 120 monitors the operation of the microprocessor 61 by the microprocessor monitor circuit 62f. Only where the judgment of normality is made at both of steps 118, 120, a supply permission command is outputted to the power supply permission circuit 63d, but in other cases, a supply inhibition command is outputted to the power supply permission circuit 63d.

When the supply permission command is outputted to the power supply permission circuit 63d, the controller 60 outputs the first supply voltage V1 from the first step-down circuit 63a1 at step 122. Then, when the sensor power voltage is being outputted normally (“YES” is judged at step 124), the third supply voltage V3 is outputted from the second step-down circuit 63a3 at step 126. At step 124, the sensor power voltage or the third supply voltage V3 is monitored by the sensor power voltage monitor and breaker circuit 63h. For example, judgment is made to be abnormal in the case of excess current, but to be normal in the absence of the excess current. When making the judgment of being abnormal, the controller 60 at step 128 controls the sensor power voltage monitor and breaker circuit 63h to make the output of the third supply voltage V3 zero volt.

In the presence of the second supply voltage break demand, the control 60 makes a judgment of “YES” at step 130 and controls the second supply voltage generation circuit 63a2 to make the output of the second supply voltage V2 zero volt at step 134. Further, in the absence of the second supply voltage break demand and in the absence of the second supply voltage transformation demand, “NO” is judged at each of steps 130 and 132, whereby at step 136, the output of the second supply voltage V2 is set by the second supply voltage generation circuit 63a2 to 10 volts being the required minimum voltage. Further, in the absence of the second supply voltage break demand and in the presence of the second supply voltage transformation demand, “NO” and “YES” are judged respectively at steps 130 and 132, whereby at step 138, the second supply voltage generation circuit 63a2 outputs as the second supply voltage V2 a voltage (i.e., required voltage value) depending on a command duty ratio. The second supply voltage transformation demand signal may be a PWM signal output or may be a serial transmission output given by means of communication.

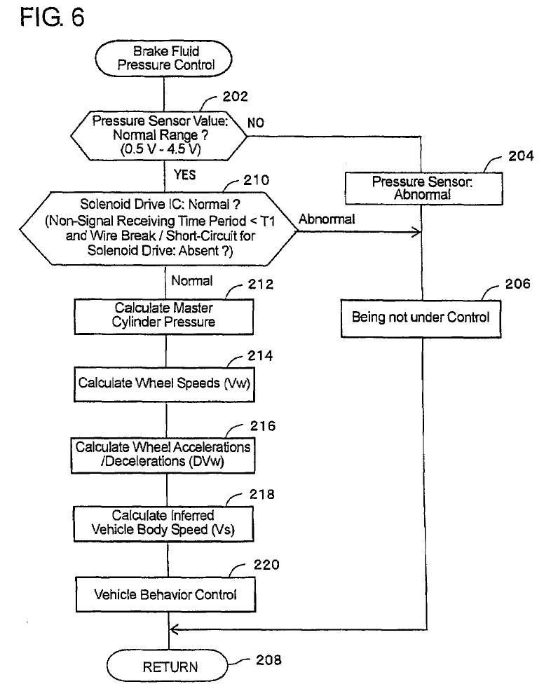

The control 60 executes a brake fluid pressure control at step 140. Specifically, a brake fluid pressure control routine is executed in accordance with the flow chart shown in FIG. 6.

The controller 60 judges at step 202 whether or not the pressure sensor P is normal. That is, the pressure sensor P is judged to be normal if a detected pressure sensor value is within a normal range (e.g., 0.5-4.5 volts), but judged to be abnormal if not. Since the controller 60 does not execute the brake fluid pressure control if the pressure sensor P is abnormal, it advances the program to step 204 to make a setting that the pressure sensor is abnormal, and then at step 206, further makes a setting that the brake fluid pressure control is not executed, that is, “being not under control”. The program is then advanced to step 208 to terminate the present routine.

Further, the controller 60 at step 210 judges whether or not the solenoid drive IC 62 involved in the brake fluid pressure control is normal. That is, the operation of the solenoid drive IC 62 is monitored by the solenoid drive IC monitor circuit 61f. Since the brake fluid pressure control is not to be executed if the solenoid drive IC 62 is abnormal, the controller 60 advances the program to step 206 to make a setting that the brake fluid pressure control is not executed, that is, “being not under control”. The program is then advanced to step 208 to terminate the present routine.

Then, when the pressure sensor P and the solenoid drive IC 62 are normal, the controller 60 calculates a master cylinder pressure (step 212), calculates the wheel speeds Vw based on detection signals detected by the wheel speed sensors Sfl-Sfr (step 214), calculates wheel acceleration/deceleration speeds DVw based on the wheel speeds Vw (step 216), calculates an inferred vehicle body speed Vs based on the wheel speeds Vw (step 218), and then, executes a vehicle behavior control based on these calculation results and the state of the downhill control switch 71 (step 220). At step 220, a control kind is determined to be selected from the ABS control, the traction control and the downhill control, and determination is made as to the demands for the driving of the electromagnetic valves or solenoids and the electric motor 26a.

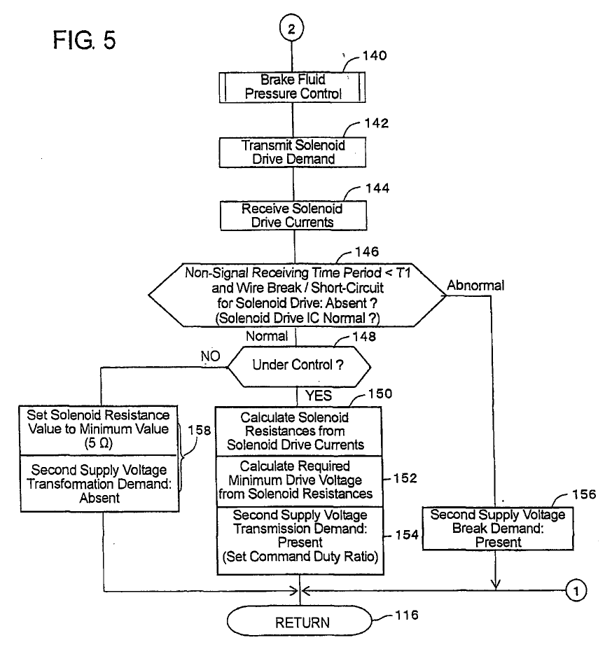

Upon termination of the aforementioned brake fluid pressure control routine, the controller 60 advances the program to step 142 shown in FIG. 5. At step 142, the controller 60 transmits the solenoid drive demand derived at step 140 to the solenoid drive IC 62 to execute a vehicle behavior control such as ABS control, traction control or downhill control.

The controller 60 receives respective drive currents for the solenoids SOL1-SOL12 from the solenoid drive IC 62 at step 144. During the execution of a vehicle behavior control and where the solenoid drive IC 62 is normal (“Normal” and “YES” respectively at steps 146 and 148), the controller 60 calculates respective resistance values across the solenoids SOL1-SOL12 (step 150). If the solenoid drive IC 62 is abnormal (“Abnormal” at step 146), the second supply voltage break demand is set to be present (step 156), and the program is then advanced to step 116 to terminate the present flow chart once. Further, when the solenoid drive IC 62 is normal and when any vehicle behavior control is not being executed (“Normal” and “NO” respectively at steps 146 and 148), a minimum resistance value (5Ω(ohms)) is set as the solenoid resistance value, the second supply voltage transformation demand is set to be absent (step 158), and the program is then advanced to step 116 to terminate the present flow chart once.

At step 150, the controller 60 calculates respective resistance values across the solenoids SOL1-SOL12 by dividing the second supply voltage V2 being the drive voltage to be applied to the solenoids SOL1-SOL12 by the respective current values flowing through the solenoids SOL1-SOL12. Further, at step 152, the controller 60 calculates a required minimum drive voltage based on the resistance values calculated at step 150. More specifically, the maximum resistance value is selected from the resistance values of the solenoids SOL1-SOL12 calculated at step 150, and the required minimum drive voltage is calculated by multiplying the maximum resistance value by a current value which corresponds to an attraction force required for the solenoids. The current value which corresponds to the attraction force required for the solenoids is varied in dependence on the kind of the vehicle behavior control. The current value is made to be variable to a required current value, which corresponds to a required attraction force depending on the output from the pressure sensor P, under the ABS control, while it is made to be variable to other required current values which correspond to other required attraction forces depending on the pressuring determined for the shut-off valve 21 (or 41). For example, the current value is 2.5 amperes under the ABS control, is 2 amperes under the downhill control and is 1.5 amperes under the traction control.

Then, at step 154, the controller 60 converts the calculated, required minimum drive voltage to a second supply voltage transformation demand signal and makes a setting that the second supply voltage transformation demand is present. The second supply voltage transformation demand signal is a signal indicative of a duty ratio representing the required minimum drive voltage, and for example, voltages of 10 to 16 volts are represented by the duty ratios of 20 to 80%. The second supply voltage transformation demand is set as a command duty ratio representing the required minimum drive voltage. The second supply voltage transformation demand signal may be a PMW signal output or may be a serial transmission output given by means of communication.

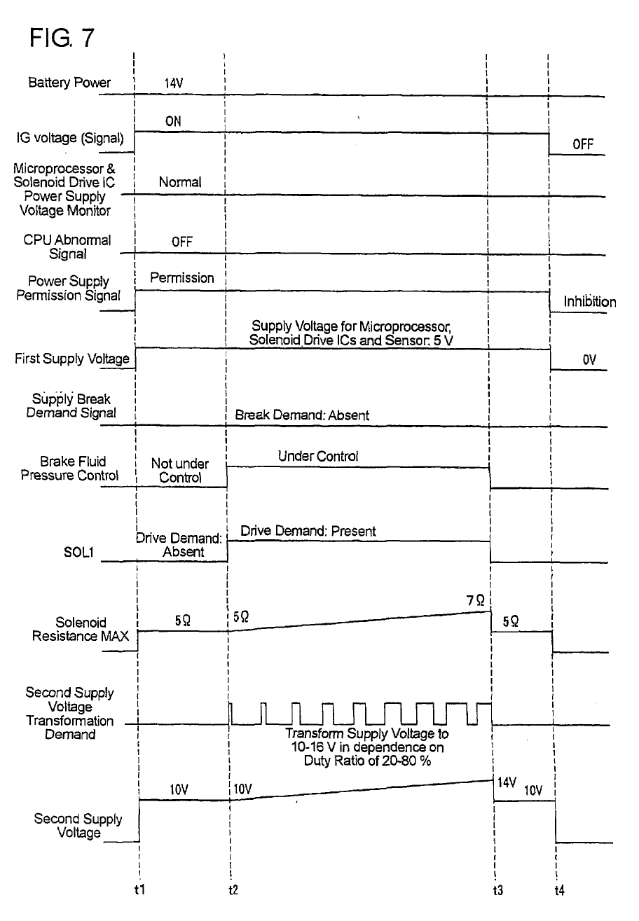

Further, the operation of the vehicle brake electronic controller as constructed above will be described in detail with the downhill control taken as example and with reference to a time chart shown in FIG. 7. The battery voltage is 14 volts. At time point t1, the ignition switch IGSW is turned to ON state. If the microprocessor/solenoid drive IC power voltage is normal (“YES” is judged at step 118) and if the microprocessor 61 is normal (“YES” at step 120), a permission is outputted to the power supply permission circuit 63d, whereby the voltage of 5 volts is outputted as the first supply voltage V1 (step 122). Further, since it has been set that the second supply voltage break demand is absent (step 108) and since the solenoid drive IC 62 remains to be normal until time point t4, the second supply voltage break demand signal remains absent.

Under the circumstance like this, when the downhill control is initiated at time point t2 as a result of the downhill control switch 71 being turned to ON state, the downhill control comes to under execution, whereby drive voltages are applied to the solenoids SOL1, SOL6, SOL7 and SOL12 being the control objects. That is, determinations are made of the drive demands on the solenoids SOL1, SOL6, SOL7 and SOL12. For simplicity in illustration, the drive demand for the solenoid SOL1 only is shown in the time chart.

As the energization time becomes longer, the temperature of the solenoids rises and the resistances values across the solenoids increase due to the heat. Thus, the maximum resistance value of the solenoids becomes greater with the progress of time. When the maximum resistance valve becomes greater, the required minimum drive voltage becomes higher, so that the duty ratio of the second supply voltage transformation demand signal also becomes larger. For example, assuming that the maximum resistance value is 5Ω at a downhill control starting time (time point t2), the second supply voltage V2 is 10 volts (=5Ω×2 A). Assuming further that the maximum resistance valve has become 7Ω at a downhill control ending time (time point t3) because the resistance value has been increased by heat, the second supply voltage V2 is 14 volts (=7Ω×2 A).

Then, when the ignition switch IGSW is turned to OFF state at a time point t4, an inhibition command is outputted to the power supply permission circuit 63d, whereby the output of the first supply voltage V1 becomes zero volt (step 114).

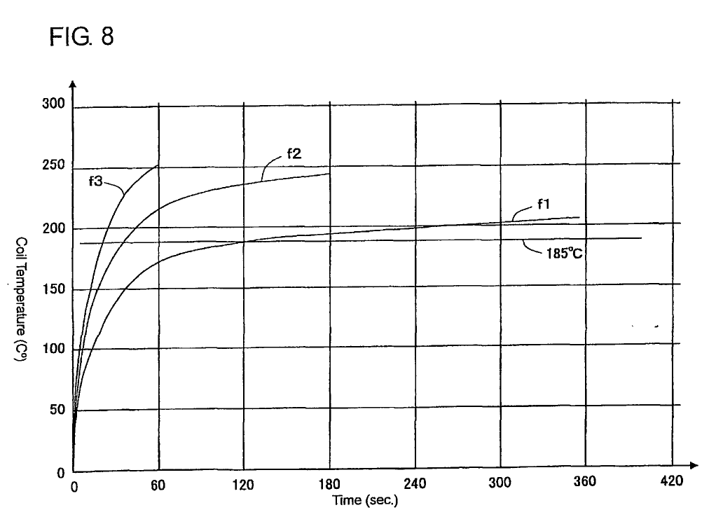

FIG. 8 shows the time-dependant variations of the coil temperature at respective drive voltages where an electromagnetic valve is energized continuously. A curve f1 represents the case of the drive voltage being 11 volts, a curve f2 represents the case of the drive voltage being 13.5 volts, and a curve f3 represents the case of the drive voltage being 15.5 volts. As clear from FIG. 8, it is understood that the increase of the coil temperature is slower in the case of the drive voltage being lower. That is, it is understood that the drive period of time (continuously energized period of time) can be made to be longer where the drive voltage is suppressed to be as low as possible.

As clear from the aforementioned description, in the first embodiment, resistance value calculation means (the solenoid resistance value calculation section 61d; step 150) calculates respective resistance values of the solenoids based on the respective drive currents detected by current detection means (the solenoid current measuring circuit 62e), required minimum drive voltage calculation means (the voltage demand calculation section 61e; step 152) calculates the required minimum drive voltage based on the resistance values calculated by the resistance value calculation means, and power supply relay means (the power supply relay IC 63) transforms the power supply voltage supplied from the power supply (the battery BAT) into the required minimum drive voltage calculated by the required minimum drive voltage calculation means to supply the voltage as the drive voltage to the solenoids SOL1-SOL12. Thus, regardless of the difference in the kinds of the controls to be executed and regardless of the fluctuation in the supply voltage from the battery BAT in dependence on the state in use, it is possible to apply an appropriate supply voltage depending on the voltage required for solenoid drive, to switching means (the switching elements 62c1-62c12). Accordingly, the heat generation of the switching elements can be suppressed to be as small as possible, so that the voltage application period of time (the continuously energized period of time) to the switching means can be extended to be as long as possible.

Further, the required minimum drive voltage calculation means (the voltage demand calculation section 61e; step 152) selects the maximum resistance value from the resistance values of the solenoids calculated by the resistance value calculation means (the solenoid resistance value calculation section 61d; step 150) and calculates the required minimum drive voltage by multiplying the maximum resistance value by the current value which corresponds to the attraction force required for the solenoids. By applying the required minimum drive voltage to all the solenoids SOL1-SOL12, it is possible to reliably secure the operations of all the solenoids SOL1-SOL12.

Further, the power supply relay means (the power supply relay IC 63) is provided with the step-down means (the step-down circuit 63a4) for stepping down the power voltage supplied from the power supply (the battery BAT) to supply the step-down voltage as the drive voltage to the solenoids and/or the step-up means (the step-up circuit 63a5) for stepping up the power voltage to supply the stepped-up voltage as the drive voltage to the solenoids. Therefore, whether the supply voltage from the battery is higher or lower than the voltage required for solenoid drive, it is possible to reliably and properly supply the solenoids with the drive voltage in a simplified construction.

Further, the switching means (the switching elements 62c1-62c12), the solenoid drive means (the solenoid drive circuit 62b) for supplying ON/OFF signal to the switching means, and the current detection means (the solenoid current measuring circuit 62e) are formed in the solenoid drive IC 62 which is a single package, and the power supply relay means (the power supply relay IC 63) is constituted as the power supply relay IC 63 which is a single package separated from the solenoid drive IC 62. Thus, the switching means (the switching elements 62c1-62c12) being a heat generation source and the power supply relay means (the power supply relay IC 63) are separated as distinct packages, so that it becomes possible to make the heat generations distributed. Accordingly, one package is prevented from being centralized in generating heat, so that the operations of integrated circuits can be prevented from being inhibited due to becoming a high temperature, and the operation period of time can be extended.

Further, the resistance value calculation means (the solenoid resistance value calculation section 61d) and the required minimum drive voltage calculation means (the voltage demand calculation section 61e) are included in the microprocessor 61 which is a single package separated from the solenoid drive IC 62 and the power supply relay IC 63. When the microprocessor 61 and the solenoid drive IC 62 are normal, the supply voltage means (the supply voltage circuit 63a) supplies the minimum voltage ensuring the operations of the microprocessor 61 and the solenoid drive IC 62, as a microprocessor power voltage and a solenoid drive IC power voltage to the microprocessor 61 and the solenoid drive IC 62. Therefore, it is possible to reliably secure the operation of the microprocessor 61 and the solenoid drive IC 62.

Further, when the microprocessor monitor means (the microprocessor monitor circuit 62f) detects the abnormality of the microprocessor 61 or when the voltage monitor means (the IC power voltage monitor circuit 63b) detects the abnormality of the microprocessor power voltage and the solenoid drive IC power voltage, the power supply breaker means (the power supply permission circuit 63d) breaks the supplying of the microprocessor power voltage and the solenoid drive IC power voltage. Therefore, it is possible to reliably execute failsafe.

Further, when the solenoid drive IC monitor means (the solenoid drive IC monitor circuit 61f) detects the abnormality of the solenoid drive IC 62 or when the microprocessor monitor means (the microprocessor monitor circuit 62f) detects the abnormality of the microprocessor 61, the drive voltage breaker means (the second supply voltage breaker circuit 63g) breaks the supplying of the drive voltages to the respective solenoids. Therefore, it is possible to reliably execute failsafe.

Although in the foregoing first embodiment, the brake fluid pressure control system A is applied to a front-wheel drive vehicle, it may be applied to a rear-wheel drive vehicle or a four-wheel drive vehicle.

Further, although in the foregoing first embodiment, electromagnetic valves have been exemplified as electric/electronic components driven by solenoids, the present invention may also be applied on other electric/electronic components driven by solenoids.

### Second Embodiment

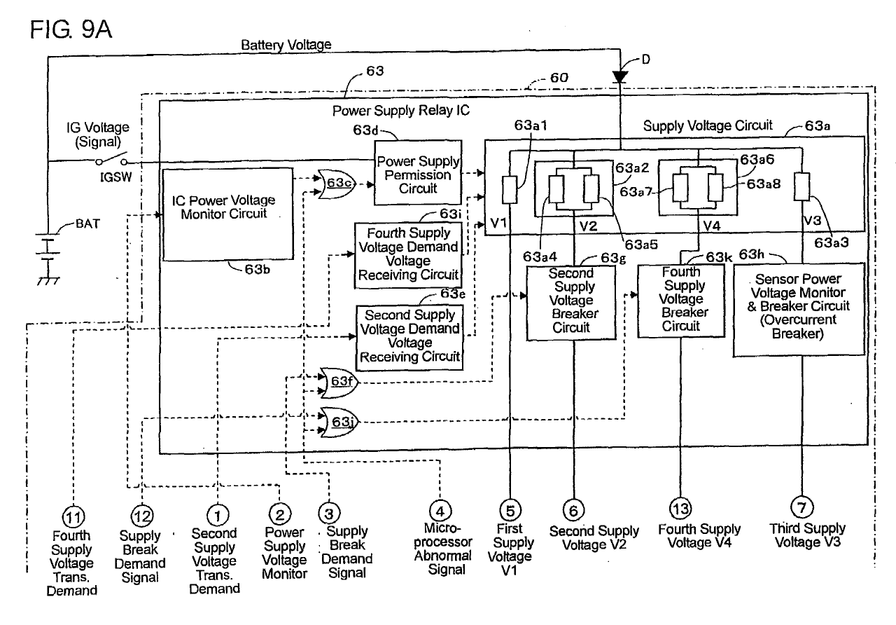

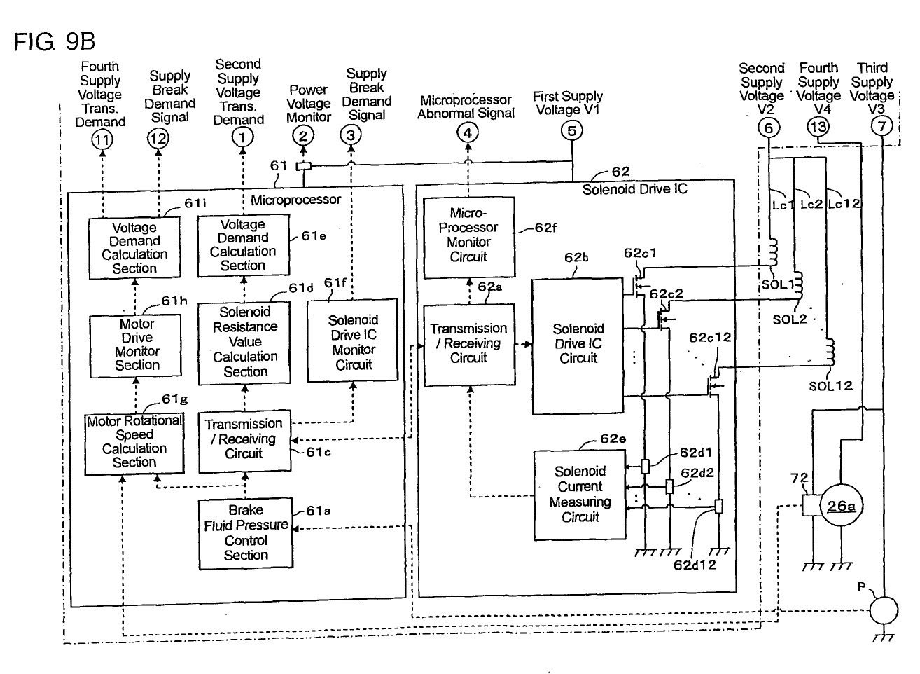

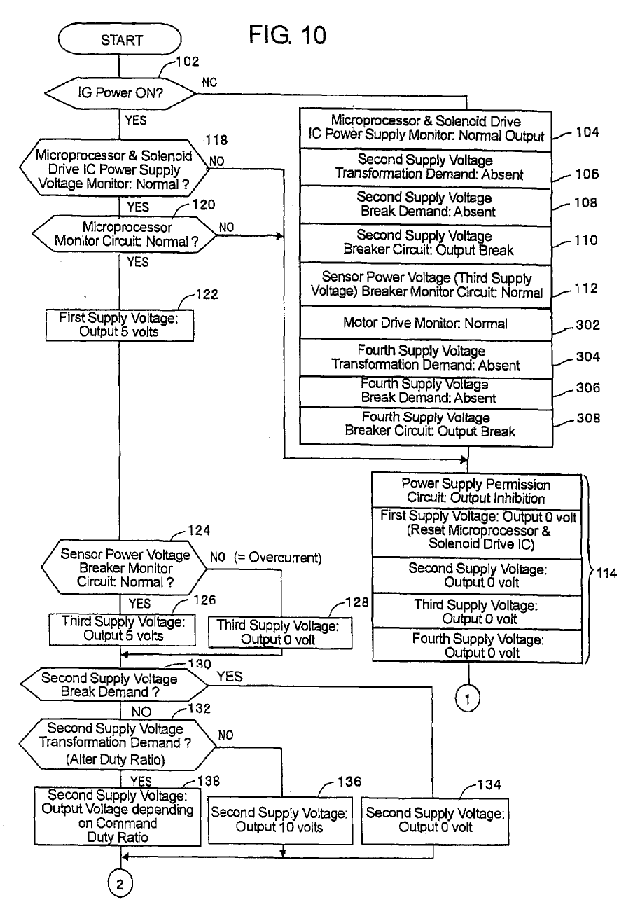

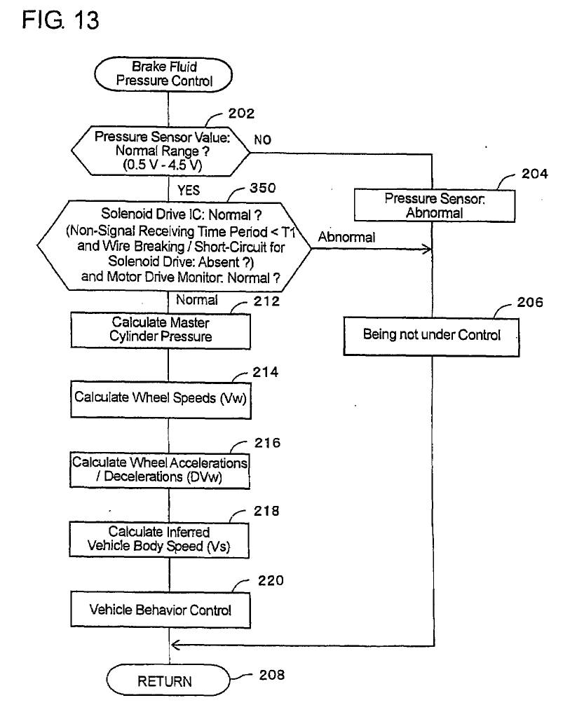

Next, with reference to the drawings, description will be made regarding a vehicle electronic controller in a second embodiment according to the present invention, wherein the controller is applied as a vehicle brake electronic controller to a brake fluid pressure control system. Although the foregoing first embodiment has been described in detail taking the solenoids as loads, the second embodiment will be described in detail taking solenoids and the electric motor 26a as loads. FIGS. 9A and 9B are schematic block diagrams collectively showing the controller in the second embodiment, FIGS. 10-12 are flow charts collectively showing a control program executed by the controller in the second embodiment, and FIG. 13 is a flow chart of the brake fluid pressure control executed by the controller in the second embodiment. The components and processing in the second embodiment which are the same or identical with those in the foregoing first embodiment will be designated by the same reference numerals, and descriptions of the same components and processing will be omitted for the sake of brevity.

As shown in FIGS. 9A and 9B, the electric motor 26a is connected in series to the power supply BAT. Further, the brake fluid pressure control system A is provided with a rotational speed sensor 72 which constitutes rotational speed detection means for detecting the rotational speed being the state of the electric motor 26a. The third supply voltage V3 is supplied from the second step-down circuit 63a3 to the rotational speed sensor 72. A detection signal from the rotational speed sensor 72 is transmitted to the microprocessor 61 of the controller 60. Further, the aforementioned pressure sensor P serves as load quantity detection means for detecting a load pressure (master cylinder pressure) which is a load quantity on the pumps 26, 46 driven by the electric motor 26a, that is, a load on the electric motor 26a. The load quantity detection means constitutes electric motor state detection means (load state detection means).

The microprocessor 61 of the controller 60 is further provided with a motor rotational speed calculation section 61g, a motor drive monitor section 61h and a voltage demand calculation section 61i in addition to those referred to in the foregoing first embodiment.

The motor rotational speed calculation section 61g calculates the rotational speed Sm of the electric motor 26a based on the detection signal from the rotational speed sensor 72. Further, the calculation section 61g receives a drive demand from the brake fluid pressure control section 61a and a master cylinder pressure from the pressure sensor P.

The motor drive monitor section 61h monitors the driving of the electric motor 26a based on the rotational speed Sm and the drive demand which are inputted from the motor rotational speed calculation section 61g. More specifically, in the presence of the drive demand, that is, under control, and in the case that the electric motor 26a has not been rotated continuously over a predetermined time T2 or that a fourth supply break demand is present, the electric motor 26a is judged to be abnormal. Otherwise, the electric motor 26a is judged to be normal. The case that the electric motor 26a has not been rotated continuously over the predetermined time T2 is the case wherein a continuous time T for the electric motor 26a remaining at a less rotational speed than a predetermined value (e.g., 0 rpm) lasts to be longer than the predetermined time T2. When detecting the abnormality of the electric motor 26a, the motor drive monitor section 61h transmits a supply break demand signal for breaking the supplying of the fourth supply voltage V4, to an OR gate 63j of the power supply relay IC 63 through the voltage demand calculation section 61i.

The voltage demand calculation section (required minimum drive voltage calculation means) 61i calculates a required minimum drive voltage which is a drive voltage to be supplied to the electric motor 26a and which is a required lowest voltage corresponding to an output power required for the electric motor 26a, based on the state of the electric motor 26a detected by the electric motor state detection means. For example, by using a map or arithmetic expressions which represent the relations between drive voltages supplied to the electric motor 26a and rotational speeds of the electric motor 26a for respective load pressures (master cylinder pressures) which are loads on the electric motor 26a, the calculation section 61i calculates the required minimum drive voltage which is a drive voltage to be supplied to the electric motor 26a and which is a required minimum voltage, by reference to the master cylinder pressure as the load pressure. The required minimum drive voltage so calculated is transmitted as the fourth supply voltage transformation demand signal to a fourth supply voltage demand voltage receiving circuit 63i of the power supply relay IC 63. The fourth supply voltage transformation demand signal may be a PWM signal output or may be a serial transmission output given by means of communication.

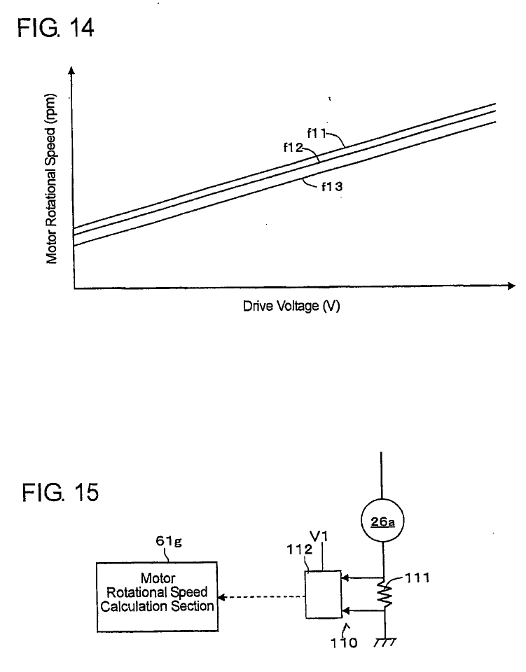

The map is stored in a storage device (not shown) provided in the controller 60. As shown in FIG. 14, a plurality of curves f11, f12 and f13 for example are defined on the map. The respective curves f11, f12 and f13 define the relations between drive voltages to be supplied to the electric motor 26a and rotational speeds of the electric motor 26a for a plurality of different load pressures (e.g., 6 Mpa (megapascal), 12 Mpa and 18 Mpa). Each curve f11, f12 or f13 defines higher drive voltages as the motor rotational speed increases. Further, the curve f11, f12 or f13 defines lower rotational speeds as the load pressure becomes higher. This is because for retention of a certain rotational speed, a higher drive voltage comes to be required at a higher load pressure. Further, interpolation using these curves f11, f12 and f13 may be performed for the relation between the drive voltage and the motor rotational speed at any other load pressure. Moreover, there may be used arithmetic expressions for providing the same effect as the map.

In addition to those in the foregoing first embodiment, the supply voltage circuit 63a of the power supply relay IC 63 is further provided with a fourth supply voltage generation circuit 63a6 for transforming the power voltage (the battery voltage) supplied from the power supply (the battery BAT) to the required minimum drive voltage to supply the same as the fourth supply voltage V4 to the electric motor 26a. That is, the supply voltage circuit 63a inputs the power voltage (the battery voltage) supplied from the power supply (the battery BAT), generates first through fourth supply voltages V1-V4 and outputs the same respectively from the output ports OUT1-OUT4 (not shown). The fourth supply voltage V4 is a voltage (e.g., 10-16 volts) which is transformably supplied as the drive voltage to the electric motor 26a.

The fourth supply voltage generation circuit 63a6 is composed of a step-down circuit (step-down means) 63a7 (same as the aforementioned step-down circuit 63a4) for stepping down the power voltage supplied from the power supply BAT so that the same becomes a required voltage value inputted from the fourth supply voltage demand voltage receiving circuit 63i, to supply the stepped-down voltage as the drive voltage to the electric motor 26a, and a step-up circuit (step-up means) 63a8 (same as the aforementioned step-up circuit 63a5) for stepping up the power voltage so that the same becomes the required voltage value inputted from the fourth supply voltage demand voltage receiving circuit 63i, to supply the stepped-up voltage as the drive voltage to the electric motor 26a. The relation in magnitude between the battery voltage and the required voltage value determines whether to use the step-down circuit 63a7 or the step-up circuit 63a8. Thus, the step-down circuit 63a7 is used when the battery voltage is higher than the required voltage value, whereas the step-up circuit 63a8 is used when the former is lower than the latter. Although not shown, in order to prevent oscillation (chattering) from occurring at the time of switching, there may be provided voltage hysteresis (i.e., giving a range to the switching judgment value) or a time filter (i.e., removing signals which last to be shorter than a predetermined period of time).

Further, the power supply relay IC 63 is provided with the fourth supply voltage demand voltage receiving circuit 63i, the OR gate 63j and a fourth supply voltage breaker circuit 63k in addition to those provided in the foregoing first embodiment.

The fourth supply voltage demand voltage receiving circuit 63i calculates a required voltage value based on the fourth supply voltage transformation demand signal inputted from the voltage demand calculation section 61i and outputs the calculation result to the fourth supply voltage generation circuit 63a6. The fourth supply voltage transformation demand signal may be a PWM signal output or may be a serial transmission output given by means of communication.

The OR gate 63j inputs a microprocessor abnormal signal (high level) from the microprocessor monitor circuit 62f or a supply break demand signal (high level) from the motor drive monitor section 61h through the voltage demand calculation section 61i and, in response to either signal, outputs a break signal (high level) instructing the break of the fourth supply voltage V4, to the fourth supply voltage breaker circuit 63k.

The breaker circuit 63k allows the supplying of the forth supply voltage V4 while the break signal is not inputted from the OR gate 63j (i.e., the break signal is at low level), but breaks the supplying of the forth supply voltage V4 while the break signal is inputted from the OR gate 63j (i.e., it is at high level).

Next, the operation of the vehicle brake electronic controller as constructed above will be described in accordance with the flow charts shown in FIGS. 10 through 13. Since the same controls as those in the foregoing first embodiment are executed basically, the same processing is designated by the same reference numeral, and description on the same processing will be omitted for the sake of brevity.

Unless the ignition switch IGSW has been turned to ON, the controller 60 repeats making a judgment of “NO” at step 102 and repetitively executes steps 102-112, steps 302-308 and step 114. At step 302, the controller 60 makes a setting that the motor drive monitor is normal. At step 304, the controller 60 makes a setting that the fourth supply voltage transformation demand is absent. At step 306, the controller 60 makes a setting that the fourth supply voltage break demand is absent. At step 308, the controller 60 sets the fourth supply voltage breaker circuit 63k to an output break mode. Further, at step 114, the controller 60 outputs a supply inhibition command to the power supply permission circuit 63d to make the outputs of the first to third supply voltages V1-V3 and the fourth supply voltage V4 zero volt.

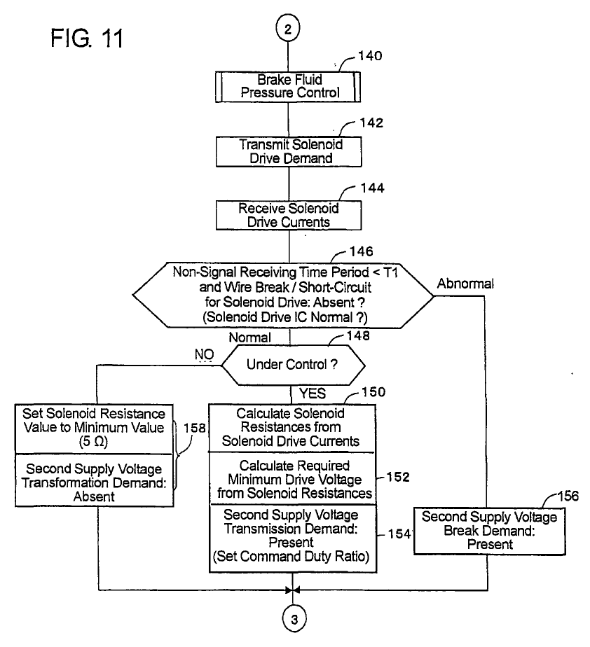

When the ignition switch IGSW is turned to ON, on the contrary, the controller 60 executes those processing subsequent to step 122 in FIG. 10 if the first supply voltage V1 and the operation of the microprocessor 61 are normal. The controller 60 supplies the first supply voltage V1 properly at step 122 and further supplies the third supply voltage V3 properly at steps 124-128, as described earlier in the first embodiment. Then, at steps 130-158 (FIG. 11), the controller 60 supplies the second supply voltage V2 properly to the solenoids under the predetermined brake fluid pressure control, as described earlier in the first embodiment.

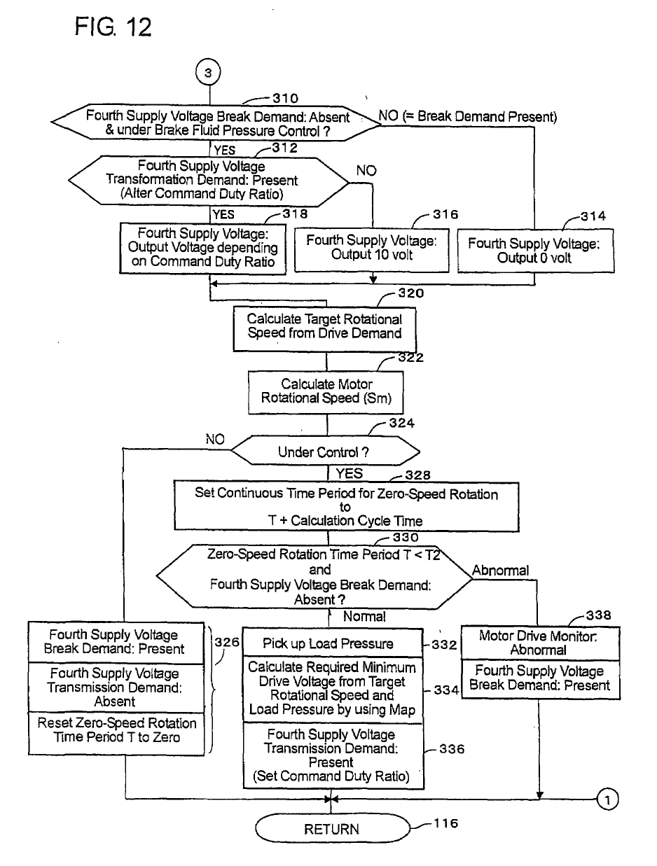

Further, at steps 310 through 338 shown in FIG. 12, the controller 60 properly supplies the forth supply voltage V4 to the electric motor 26a under the predetermined brake fluid pressure control.

In the presence of the fourth supply voltage break demand or not under the brake fluid pressure control, the controller 60 makes a judgment of “NO” at step 310 and sets the output of the forth supply voltage V4 to zero volt by the fourth supply voltage generation circuit 63a6 at step 314. Further, in the absence of the fourth supply voltage break demand and under the brake fluid pressure control and in the absence of the fourth supply voltage transformation demand, the controller 60 makes judgments of “YES” and “NO” respectively at steps 310 and 312 and sets the output of the forth supply voltage V4 to 10 volt being the required lowest voltage by the fourth supply voltage generation circuit 63a6 at step 316. Further, in the absence of the fourth supply voltage break demand, under the brake fluid pressure control and in the presence of the fourth supply voltage transformation demand, the controller 60 makes judgments of “YES” at steps 310 and 312 and outputs a voltage (i.e., a required voltage value) corresponding a command duty ratio by the fourth supply voltage generation circuit 63a6 at step 318. The fourth supply voltage transformation demand signal may be a PWM signal output or may be a serial transmission output given by means of communication.

At step 320, the controller 60 calculates a target rotational speed of the electric motor 26a based on the drive demand of the electric motor 26a determined earlier at step 140. This rotational speed is determined in dependence on a selected kind of the aforementioned brake controls, the state of the traveling road surface and the like. Then, at step 322, the controller 60 calculates the rotational speed Sm of the electric motor 26a based on the detection signal from the rotational speed sensor 72 constituting electric motor state detection means.

Then, when making a judgment of being not under the brake fluid pressure control (“NO” at step 324), the controller 60 makes a setting that the fourth supply voltage break demand is present, makes a setting that the fourth supply voltage transformation demand is absent, and resets the continuous time T in the state that the rotational speed is zero, to zero (step 326), after which the controller 60 advances the program to step 116 to terminate the present flow chart.

On the contrary, when making a judgment of being under the brake fluid pressure control (“YES” at step 324), the controller 60 increments the aforementioned continuous time T (makes the addition of the five-millisecond operation cycle time at step 328) and then, judges whether or not the electric motor 26a remains stopped for a longer time than the predetermined time T2, based on the continuous time T (step 330). That is, if the continuous time T is longer than the predetermined time T2, the electric motor 26a is judged not to be operating normally.

When judging at step 330 that the electric motor 26a is not rotating at a faster speed than the predetermined rotational speed (e.g., 0 rpm) for the predetermined time T2 or longer or that the fourth supply voltage break demand is present, the controller 60 judges that the electric motor 26a is abnormal and makes a setting that the motor drive monitor is abnormal and a setting that the fourth supply voltage break demand is present (step 338). On the other hand, when the electric motor 26a is rotating at a faster speed than the predetermined rotational speed without remaining stopped for the predetermined time T2 or longer and when the fourth supply voltage break demand is absent, the controller 60 judges that the electric motor 26a is normal. Then, the controller 60 calculates a required minimum drive voltage which is a required lowest voltage corresponding to the target rotational speed, based on the load pressure and the target rotational speed of the electric motor 26a and by reference to the map shown in FIG. 14 (steps 332 and 334).

More specifically, the controller 60 picks up the master cylinder pressure as the load pressure from the pressure sensor P (step 332), determines a curve corresponding to the picked-up load pressure on the map (performs a compensation from two curves if a corresponding curve is not found), and calculates a drive voltage for the electric motor 26a from the determined curve and the target rotational speed calculated at step 320 (step 334).

Although not shown, in the case of the target rotational speed>Sm+A (Sm: rotational speed of the electric motor 26a), that is, where the actual rotational speed differs from the target rotational speed, a compensation can be performed to add a predetermined value to the required minimum drive voltage for enhancement of the responsiveness to the target rotational speed.

Then, at step 336, the controller 60 converts the required minimum drive voltage so calculated into the fourth supply voltage transformation demand signal and makes a setting that the fourth supply voltage transformation demand is present. The fourth supply voltage transformation demand signal is a signal indicative of a duty ratio representing the required minimum drive voltage, and for example, the voltages of 10-16 volts are represented by duty ratios of 20-80%. This fourth supply voltage transformation demand signal is set as a command duty ratio representing the required minimum drive voltage. The fourth supply voltage transformation demand signal may be a PWM signal output or may be a serial transmission output given by means of communication.

Further, the controller 60 executes the processing at step 350 shown in FIG. 13 in place of the processing at the aforementioned step 210 shown in FIG. 6. The controller 60 judges whether or not the electric motor 26a is normal, in addition to the judgment of whether or not the solenoid drive IC 62 taking part in the brake fluid pressure control is normal. That is, the operation of the electric motor 26a is monitored by the motor drive monitor section 61h. If the electric motor 26a is abnormal, the controller 60 does not execute the brake fluid pressure control and advances the program step 206 to set “being not under control” indicating that the brake fluid pressure control is not being executed. Thereafter, the controller 60 advances the program to step 208 to terminate the present routine.

As clear from the foregoing description, in the second embodiment, the required minimum drive voltage calculation means (61i; step 334) calculates the required minimum drive voltage which is the drive voltage to be supplied to the electric motor 26a and which is the required lowest voltage corresponding to the require power for the electric motor 26a, based on the state (the load quantity) of the electric motor 26a detected by the electric motor state detection means (the pressure sensor P), and the power supply relay means (63) transforms the power voltage supplied from the power supply (BAT) into the required minimum drive voltage calculated by the required minimum drive voltage calculation means (61i; step 334) and supplies the transformed voltage as the drive voltage to the electric motor 26a. Therefore, regardless of the difference in the kinds of the controls to be executed and regardless of the fluctuation in the supply voltage from the battery BAT in dependence on the state in use, it is possible to apply to the electric motor 26a an appropriate voltage corresponding to the voltage required for the drive of the electric motor 26a. Accordingly, the heat generation of the electric motor 26a can be suppressed to be as small as possible, so that the voltage application period of time to the electric motor 26a can be extended to be as long as possible.

Further, since the fourth supply voltage generation circuit 63a6 steps up or down the voltage from the battery BAT to the required minimum drive voltage, the switching elements 81, 91, 96 and the coils 83, 93 generate heat. On the other hand, the electric motor 26a can avoid generating superfluous heat as a result of being supplied with the required minimum drive voltage only. Accordingly, the heat generation is divided into those from the power supply relay 63 and the electric motor 26a, so that the heat generation can be suppressed from being concentrated on one component.

Further, since no higher voltage than that required is applied to the electric motor 26a, the same is suppressed from rotating at a higher speed than that required, so that it becomes possible to suppress the noise caused by the operation of the electric motor 26a from getting more than as required. Further, since the voltage applied to the electric motor 26a is not a voltage altered under the PMW control but a constant voltage, the removal of the rotational fluctuation successfully results in reducing the operation noise, and a surge current to the electric motor 26a at the time of switching the applied voltage from OFF to ON (or ON to OFF) is removed to suppress the electric motor 26a from generating superfluous heat.

Further, the electric motor state detection means is constituted by load quantity detection means (the pressure sensor P) for detecting the load quantity on the electric motor 26a, and the required minimum drive voltage detection means calculates the required minimum drive voltage which is the drive voltage to be supplied to the electric motor 26a and which is the required lowest voltage, based on the load quantity by using the map or the calculation expressions which define the relations between the drive voltages to be supplied to the electric motor 26a and the rotational speeds of the electric motor 26a for respective load quantities on the electric motor 26a. Thus, the required minimum drive voltage which is the drive voltage to be supplied to the electric motor 26a and which is the required lowest voltage can be calculated reliably and directly, and hence, the heat generation of the electric motor 26a can be suppressed reliably, so that it is ensured to extend the voltage application period of time to the electric motor 26a.

Further, the power supply relay means (the power supply relay IC 63) is provided with the supply voltage circuit (the supply voltage means) 63a having the fourth supply voltage generation circuit 63a6 which is composed of the step-down circuit (step-down means) 63a7 for stepping down the power voltage supplied from the power supply BAT to supply the stepped-down voltage as the drive voltage to the electric motor 26a and/or the step-up circuit (the step-up means) 63a8 for stepping up the power voltage to supply the stepped-up voltage as the drive voltage to the electric motor 26a. Thus, whether the supply voltage from the battery BAT is higher or lower than the voltage required for the driving of the electric motor 26a, it is possible to reliably and properly supply the electric motor 26a with the drive voltage in a simplified construction.

Further, the required minimum drive voltage calculation means (the voltage demand calculation section 61e) is included in the microprocessor 61, and the supply voltage circuit (supply voltage means) 63a is provided with the first step-down circuit (voltage regulator means) 63a1 for supplying the lowest voltage, which secures the operation of the microprocessor 61, as the microprocessor power voltage to the microprocessor 61 when the same is normal. Therefore, it is possible to reliably secure the operation of the microprocessor 61.

Further, the drive voltage breaker means (the fourth supply voltage breaker circuit 63k) brakes the supplying of the drive voltage to the electric motor 26a when the electric motor monitor means (the motor drive monitor section 61h) detects the abnormality of the electric motor 26a or when the microprocessor monitor means (the microprocessor monitor circuit 62f) detects the abnormality of the microprocessor 61. Therefore, it is possible to execute a failsafe reliably.

Further, as clear from the foregoing description, in the first and second embodiments, the required minimum drive voltage calculation means (61e, 61i; steps 152, 334) calculates the required minimum drive voltage which is the drive voltage to be supplied to the load (the solenoids, the electric motor 26a) and which is the required lowest voltage, based on the state of the load detected by the load state detection means (the solenoid current measuring circuit 62e, the pressure sensor P), and the power supply relay means (63) transforms the power voltage supplied from the power supply into the required minimum drive voltage calculated by the required minimum drive voltage calculation means and supplies the transformed voltage as the drive voltage to the load. Therefore, regardless of the difference in the kinds of the controls to be executed and regardless of the fluctuation in the supply voltage from the battery in dependence on the state in use, it is possible to apply an appropriate voltage corresponding to the voltage required for the driving of the load (the solenoids, the electric motor 26a), to the load or the switching means (62c1-62c12) for the load. Accordingly, the heat generation of the load or the switching means for the load can be suppressed to be as small as possible, so that the voltage application time period to the load or the switching means for the load can be extended to be as long as possible.

Further, by applying the vehicle electronic controller to the vehicle brake electronic controller, the heat generation from the same can be suppressed properly, so that the time period for the brake control can be secured to be long.

In the foregoing second embodiment, the master cylinder pressure representing the load quantity of the electric motor 26a is detected to calculate the required minimum drive voltage from the master cylinder pressure. Instead, the drive current of the electric motor 26a may be detected to calculate the resistance value of the electric motor 26a and hence, the required minimum drive voltage based on the detected drive current.

In this modified form, the electric motor state detection means is constituted by a current detection device 110 (current detection means) for detecting the drive current flowing through the electric motor 26a. As shown in FIG. 15, the current detection device 110 is composed of a shunt resistance 111 and a current detection circuit 112. The shunt resistance 111 is connected between the electric motor 26a and the ground, and the opposite ends of the shunt resistance 111 are connected to the current detection circuit 112. The current detection circuit 112 inputs the voltage value of the shunt resistance to detect the current value (drive current) flowing through the electric motor 26a and transmits the detection result to the motor rotational speed calculation section 61g. The first supply voltage V1 is supplied to the current detection circuit 112.

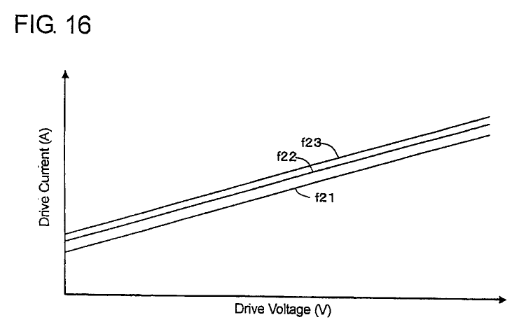

In this modified form, the required minimum drive voltage detection means calculates the required minimum drive voltage which is the drive voltage to be supplied to the electric motor 26a and which is the required lowest voltage, from the load quantity on the electric motor and the drive voltage to the same by using a map (shown in FIG. 16) or calculation expressions which define the relations between drive voltages supplied to the electric motor 26a and drive currents flowing through the same for respective load quantities on the electric motor 26a.

The map shown in FIG. 16 is stored in the storage device (not shown) provided in the controller 60 and defines a plurality of curves f21, f22 and f23 for example. The respective curves f21, f22 and f23 define the relations between drive voltages supplied to the electric motor 26a and drive currents flowing through the same for a plurality of different load pressures (e.g., 6 Mpa (megapascal), 12 Mpa and 18 Mpa). Each curve f21, f22 or f23 defines a higher drive voltage as the drive current increases. Further, the curve f21, f22 or f23 is made to be higher in level as the load pressure becomes higher. This means that the drive current is increased as the load pressure increases.

As described above, the electric motor state detection means is constituted by the load quantity detection means (the pressure sensor P) for detecting the load quantity on the electric motor 26a, the required minimum drive voltage detection means calculates the required minimum drive voltage which is the drive voltage to be supplied to the electric motor 26a and which is the required lowest voltage, from the load quantity on the electric motor 26a and the drive current flowing through the same by using the map or the calculation expressions which define the relations between the drive voltages supplied to the electric motor 26a and the drive currents flowing through the same for the respective load quantities on the electric motor 26a. Therefore, the required minimum drive voltage which is the drive voltage to be supplied to the electric motor 26a and which is the required lowest voltage can be calculated reliably, whereby the heat generation of the electric motor 26a can be suppressed reliably. Accordingly, the voltage application period of time to the electric motor 26a can be extended surely.

Although in the foregoing respective embodiments, the vehicle electronic controller is applied to the vehicle brake electronic controller, it may be applied to any other electronic controller for vehicles.

Obviously, numerous further modifications and variations of the present invention are possible in light of the above teachings. It is therefore to be understood that within the scope of the appended claims, the present invention may be practiced otherwise than as specifically described herein.

What is claimed is:

1. A vehicle electronic controller comprising:
at least one load connected in series to a power supply;
load state detection means for detecting the state of the at least one load;
required minimum drive voltage calculation means for calculating a required minimum drive voltage which is a drive voltage to be supplied to the at least one load and which is a required lowest voltage, based on the state of the at least one load detected by the load state detection means; and
power supply relay means arranged between the power supply and the at least one load for transforming a power voltage supplied from the power supply into the required minimum drive voltage calculated by the required minimum drive voltage calculation means to supply the transformed voltage as the drive voltage to the at least one load.

2. A vehicle electronic controller comprising:
a plurality of solenoids connected to a power supply in series and mutually in parallel for respectively selectively driving a plurality of electric/electronic components;
a plurality of switching means provided in series respectively to a plurality of current supply paths which are provided for applying drive current from the power supply to the respective solenoids, for making the drive voltages thereto ON or OFF independently of one another in dependence respectively on ON/OFF signals supplied thereto independently;
current detection means for detecting drive currents flowing respectively through the solenoids;
resistance value calculation means for calculating respective resistance values across the solenoids based on the respective drive currents detected by the current detection means;
required minimum drive voltage calculation means for calculating a required minimum drive voltage based on the resistance values detected by the resistance value calculation means; and
power supply relay means arranged between the power supply and the solenoids for transforming a power voltage supplied from the power supply into the required minimum drive voltage calculated by the required minimum drive voltage calculation means to supply the transformed voltage as the drive voltage to the respective solenoids.

3. The vehicle electronic controller as set forth in claim 2, wherein the required minimum drive voltage calculation means selects the maximum resistance value from the respective resistance values of the solenoids calculated by the resistance value calculation means and calculates the required minimum drive voltage by multiplying the maximum resistance value by a current value corresponding to an attraction force required for the solenoids.

4. The vehicle electronic controller as set forth in claim 2, wherein the power supply relay means includes supply voltage means having at least one of:
step-down means for stepping down the power voltage supplied from the power supply to supply the stepped-down voltage as the drive voltage to the solenoids; and
step-up means for stepping up the power voltage to supply the stepped-up voltage as the drive voltage to the solenoids.

5. The vehicle electronic controller as set forth in claim 2, further comprising solenoid drive means for supplying the ON/OFF signals to the switching means, and wherein:
the solenoid drive means, the switching means and the current detection means are formed in a solenoid drive IC being a single package; and
the power supply relay means is constituted as a power supply relay IC which is a single package separated from the solenoid drive IC.

6. The vehicle electronic controller as set forth in claim 5, wherein:
the resistance value calculation means and the required minimum drive voltage calculation means are included in a microprocessor which is a single package separated from the solenoid drive IC and the power supply relay IC; and
the supply voltage means further includes voltage regulator means for supplying a minimal voltage which secures the operations of the microprocessor and the solenoid drive IC, as microprocessor power voltage and solenoid drive IC power voltage to the microprocessor and the solenoid drive IC when the microprocessor and the solenoid drive IC are normal.

7. The vehicle electronic controller as set forth in claim 6, wherein:
the solenoid drive IC includes microprocessor monitor means for monitoring the operation of the microprocessor; and
the power supply relay IC includes:
voltage monitor means for monitoring a power voltage for the microprocessor and the solenoid drive IC; and
voltage supply breaker means for breaking the supplying of the power voltage for the microprocessor and the solenoid drive IC when the microprocessor monitor means detects the abnormality of the microprocessor or when the voltage monitor means detects the abnormality in the power voltage for the microprocessor and the solenoid drive IC.

8. The vehicle electronic controller as set forth in claim 7, wherein:
the microprocessor is provided with solenoid drive IC monitor means for monitoring the operation of the solenoid drive IC; and
the power supply relay IC further includes drive voltage breaker means for breaking the supplying of the drive voltage to the respective solenoids when the solenoid drive IC monitor means detects the abnormality of the solenoid drive IC or when the microprocessor monitor means detects the abnormality of the microprocessor.

9. A vehicle electronic controller comprising:
an electric motor connected in series to a power supply;
electric motor state detection means for detecting the state of the electric motor;
required minimum drive voltage calculation means for calculating a required minimum drive voltage which is a drive voltage to be supplied to the electric motor and which is a required lowest voltage corresponding to an output power required for the electric motor, based on the state of the electric motor detected by the electric motor state detection means; and
power supply relay means arranged between the power supply and the electric motor for transforming a power voltage supplied from the power supply into the required minimum drive voltage calculated by the required minimum drive voltage calculation means to supply the transformed voltage as the drive voltage to the electric motor.

10. The vehicle electronic controller as set forth in claim 9, wherein:
the electric motor state detection means is constituted by load quantity detection means for detecting a load quantity on the electric motor; and
the required minimum drive voltage calculation means calculates the required minimum drive voltage which is the drive voltage to be supplied to the electric motor and which is the required lowest voltage, from the load quantity on the electric motor by using a map or calculation expressions which define the relations between drive voltages supplied to the electric motor and rotational speeds of the electric motor for respective load quantities on the electric motor.

11. The vehicle electronic controller as set forth in claim 9, wherein:
the electric motor state detection means is constituted by load quantity detection means for detecting a load quantity on the electric motor; and
the required minimum drive voltage calculation means calculates the required minimum drive voltage which is the drive voltage to be supplied to the electric motor and which is the required lowest voltage, from the load quantity and drive current of the electric motor by using a map or calculation expressions which define the relations between drive voltages to be supplied to the electric motor and drive currents flowing through the electric motor for respective load quantities on the electric motor.

12. The vehicle electronic controller as set forth in claim 9, wherein the power supply relay means includes supply voltage means having at least one of:
step-down means for stepping down the power voltage supplied from the power supply to supply the stepped-down voltage as the drive voltage to the electric motor; and
step-up means for stepping up the power voltage to supply the stepped-up voltage as the drive voltage to the electric motor.

13. The vehicle electronic controller as set forth in claim 12, wherein:
the required minimum drive voltage calculation means is included in a microprocessor; and
the supply voltage means further includes voltage regulator means for supplying a minimal voltage which secures the operation of the microprocessor, as microprocessor power voltage to the microprocessor when the microprocessor is normal.

14. The vehicle electronic controller as set forth in claim 13, further comprising a microprocessor monitor means for monitoring the operation of the microprocessor, and wherein:
the microprocessor includes electric motor monitor means for monitoring the operation of the electric motor; and
the power supply relay means includes drive voltage breaker means for breaking the supplying of the drive voltage to the electric motor when the electric motor monitor means detects the abnormality of the electric motor or when the microprocessor monitor means detects the abnormality of the microprocessor.

15. A vehicle brake electronic controller for controlling brakes of a vehicle, wherein the vehicle electronic controller as set forth in claim 1 is applied as the vehicle brake electronic controller.

16. A vehicle brake electronic controller for controlling brakes of a vehicle, wherein the vehicle electronic controller as set forth in claim 2 is applied as the vehicle brake electronic controller.

17. A vehicle brake electronic controller for controlling brakes of a vehicle, wherein the vehicle electronic controller as set forth in claim 9 is applied as the vehicle brake electronic controller.
